(19) United States
(12) Patent Application Publication
(10) Pub. No.: US 2011/0066952 A1
(43) Pub. Date: Mar. 17, 2011

(54) Digital Field Marking Kit For Bird Identification

(75) Inventor: Heather Christine Kinch, Encinitas, CA (US)

(73) Assignee: HEATHER KINCH STUDIO, LLC, Encinitas, CA (US)

(21) Appl. No.: 12/884,062

(22) Filed: Sep. 16, 2010

Related U.S. Application Data
(60) Provisional application No. 61/243,484, filed on Sep. 17, 2009.

(51) Int. Cl. G06F 3/01

(52) U.S. Cl. 715/744

(57) ABSTRACT

Methods, systems, and apparatus, including computer programs encoded on a computer storage medium use computer systems for bird identification. In one aspect, a method includes presenting, on a mobile device, selectable templates showing bird body shapes; receiving input, on the mobile device, indicating colors for predefined regions of a bird body shown in a selected template of the multiple selectable templates, the indicated colors corresponding to an observed bird; and storing information representing the indicated colors for the predefined regions of the bird body for later identification of the observed bird. In another aspect, a system includes: one or more computers to provide one or more services; a network coupled with the one or more computers; and a mobile computing device configured to connect to the network and the one or more computers by wireless communication; where the mobile computing device is programmed to perform operations as described herein.

### CROSS-REFERENCE TO RELATED APPLICATIONS

This application claims the benefit of the priority of U.S. Provisional Application Ser. No. 61/243,484, filed Sep. 17, 2009 and entitled “Digital Field Marking Kit For Bird Identification”.

### COPYRIGHT NOTICE

A portion of the disclosure of this patent document (in FIGS. 3A-3J, 4A-4K, 5A-5H, and 6B-6O) contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND

This specification relates to bird identification using computer systems.

In the field, birders face many identification challenges. First, birds can move quickly in and out of cover. More often than not, an observer has but a few seconds to see key identifying marks, often under less than ideal viewing conditions such as poor light, great distances, the innate shyness of birds, etc. Second, a typical daylong outing might result in over 100 different species sightings, many (if not most) of which cannot be positively confirmed (if ever) until long after the sighting.

Bird observers in the field may carry at least one heavy hard copy field guide, as well as notebooks, sketchbooks, writing and drawing implements, food, water, and an array of optical equipment including cameras, scopes, binoculars and tripods. These are heavy and cumbersome. The fatigue associated with carrying this much paraphernalia is extreme, and can affect both observation accuracy and enjoyment.

Species identification processes currently involve incomplete, imprecise, hand drawn or hand written notations jotted in field notebooks, or poorly captured photographic images that are then compared with field guides. With more than 900 different bird species in North America and over 10,000 worldwide, this can be a daunting procedure for the average birding enthusiast and can result in discouragement and a plethora of unconfirmed identifications.

Various electronic field guides are available. Electronic field guides are encyclopedic guides that allow the user to select a bird by name, see the bird image, listen to the bird song/call, view range maps, read general bird species information, filter birds geographically, and keep a checklist of bird sightings. These guides may have all 900 North American bird species, or only some of them. In addition, some bird listing apps allow the user to list each bird sighting, listen to a bird's song or call, or to check off sightings of birds known to be in a certain area.

### SUMMARY

This specification describes technologies relating to the use of computer systems for bird identification.

In general, one innovative aspect of the subject matter described in this specification can be embodied in methods that include the actions of presenting, on a mobile device, selectable templates showing bird body shapes; receiving input, on the mobile device, indicating colors for predefined regions of a bird body shown in a selected template of the multiple selectable templates, the indicated colors corresponding to an observed bird; and storing information representing the indicated colors for the predefined regions of the bird body for later identification of the observed bird. Other embodiments of this aspect include corresponding systems, apparatus, and computer programs, configured to perform the actions of the methods, encoded on computer storage devices.

These and other embodiments can each optionally include one or more of the following features. The method can include receiving input, on the mobile device, indicating a bird type from among multiple bird types; identifying the selectable templates for the presenting based on the input indicating the bird type; receiving input, on the mobile device, indicating the selected template of the multiple selectable templates; and receiving input, on the mobile device, indicating one or more sub-templates of the selected template to finalize a configuration of the selected template for use in receiving the input indicating the colors for the predefined regions. Receiving the input indicating the bird type can include receiving the input indicating the bird type from among the multiple bird types including (i) songbirds, (ii) backyard birds, (iii) waterfowl, (iv) birds of prey, (v) shorebirds and marsh birds, (vi) wading birds, (vii) seabirds, and (viii) game birds.

Receiving the input indicating the selected template can include receiving input indicating a bird head shape template, and receiving the input indicating the one or more sub-templates can include receiving input indicating a bill shape sub-template and a tail shape sub-template. Receiving the input indicating the colors for the predefined regions can include receiving, on a touch screen of the mobile device, a drag-and-drop between a location on a color pallet and any location in a predefined region corresponding to an anatomical region of the observed bird, the method including: displaying a color, corresponding to the location on the color pallet, snapping to the predefined region, corresponding to the anatomical region of the observed bird. The method can include receiving input indicating a gradient for a previously applied color in a first predefined region of the selected template; and receiving input indicating an opacity for a previously applied color in a second predefined region of the selected template.

The method can include: receiving input indicating an erasure of previously applied colors, where the erasure crosses a boundary between two predefined regions of the selected template; and receiving input to apply one or more patterns to the selected template, where the one or more patterns cross the boundary between the two predefined regions of the selected template. In addition, the storing can include storing date, time and location on Earth data obtained from the mobile device in a file along with the information representing the indicated colors, the method including: sending the file to a bird species database system for identification of the observed bird.

The subject matter described in this specification can be embodied in a computer-readable medium encoded with a computer program including instructions that cause data processing apparatus to perform operations of the various methods. The subject matter described in this specification can also be embodied in a system that includes: one or more computers to provide one or more services; a network coupled with the one or more computers; and a mobile computing device configured to connect to the network and the one or more computers by wireless communication; where the mobile computing device is programmed to perform operations as described herein.

The mobile device can include a touch screen, and receiving the input indicating the colors for the predefined regions can include receiving on the touch screen a drag-and-drop between a location on a color pallet and any location in a predefined region corresponding to an anatomical region of the observed bird, where the operations include displaying a color snapping to the predefined region. Moreover, the system can include: a bird species database system; where the storing includes storing date, time and location on Earth data obtained from the mobile device in a file along with the information representing the indicated colors; and the operations can include sending the file to the bird species database system for identification of the observed bird.

Particular embodiments of the subject matter described in this specification can be implemented so as to realize one or more of the following advantages. A software application, which can be designed for mobile touch-screen devices, can be provided that effects observation/auto-notation functions. The software application can assist birders of all skill levels in readily capturing enough key visual information about a bird to make a positive species identification. Using the software application can obviate a birder's need to carry books, field guides and other paraphernalia in the field when cataloging identification markings on birds.

Birders using the software application can identify birds in natural settings, such as a birder's backyard or some remote location, without needing to rely on field guide photographs of bird species that are typically shot in controlled lighting environments with expensive blinds, feeders, cameras and lenses. The software application can allow birders to capture critical identification features regardless of unfavorable conditions.

Using the software application, the user need not search through both hard copy and electronic field guides, but rather can rely upon features of birds observed in the field. Instead of sorting through thousands of image options available in encyclopedic compilations of bird species photographs and illustrations, the birder can identify the sighted bird one a feature at a time. Instead of having to access an existing knowledge base and deciding where to begin looking (e.g., in hardcopy field guides or electronic encyclopedias), birdwatchers can quickly and easily create custom bird marking graphics to identify specific birds. In some implementations, the graphic can provide the advantage of being saved for later research and confirmation, so that the birder can move on to more field sightings.

The software application can serve as an observation and recording tool that allows the user to build feature-rich bird marking diagrams by selecting from among unique templates and color palettes. The finished graphic diagram can represent specific visual information that is recorded from observations at the time of the sighting. This can improve and simplify the process of making a positive species identification.

For the non-birder who may be interested in becoming a birder, the software application, by replacing hardcopy and other bulky items with a step-by-step interface, can provide a “Wow” factor that can make bird identification more fun. The software application can include interactive characteristics that can provide an inherent “gaming” look and feel that may appeal to ages and demographics not currently associated with birding.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a diagram showing an example system that includes a bird identification application.

FIG. 2 is a flow chart of an example process for bird identification.

FIGS. 3A-3J show an example sequence of screens that can be used to implement the bird identification application of FIG. 1 on a mobile smartphone.

FIGS. 4A-4K show example screens that can be used to implement the bird identification application of FIG. 1.

FIGS. 5A-5H show an example sequence of screens that can be used to implement the bird identification application of FIG. 1 on a mobile smartphone.

FIGS. 6A-6O show example screens that can be used to implement the bird identification application of FIG. 1 on a mobile smartphone.

FIG. 7 shows example generic computers that may be used with the techniques described here.

Like reference numbers and designations in the various drawings indicate like elements.

### DETAILED DESCRIPTION

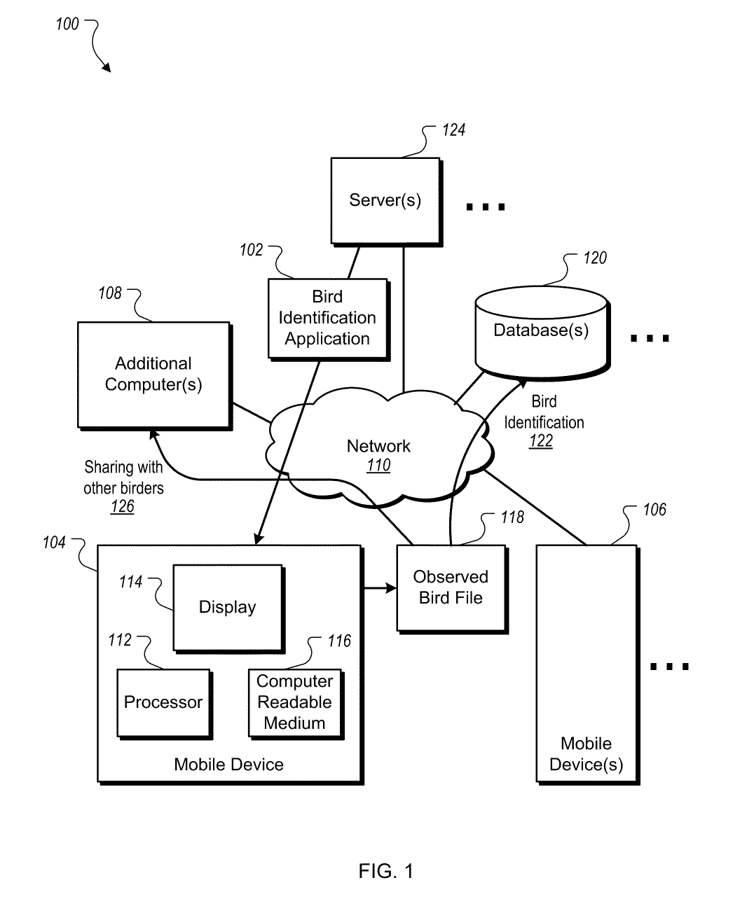

As shown in FIG. 1, an example system 100 includes a bird identification application 102 that a user can execute on his mobile device 104 to help to identify birds while bird-watching (or birding) in the field. The system 100 includes one or more computers, such as the user's mobile device 104, other users' mobile devices 106, and additional computers 108, all of which are coupled using a network 110 (e.g., a mobile phone network, a wireless local area network (WLAN), one or more proprietary or public computer networks, the Internet, or a combination of these). The user's mobile device 104 and the other users' mobile devices 106 can be configured to connect to the network 110 and the additional computers 108 using a wireless communication.

The mobile device 104 includes a processor 112 that is capable of executing computer applications, such as the bird identification application 102 (or application 102). The application 102 is programmed to provide selectable templates showing bird body shapes that can be displayed on a display 114. For example, the selectable templates that show bird body shapes can be displayed on the screen of the user's mobile device 104 while the user is birding. A computer readable medium 116 within the mobile device 104 can store the selectable template and other data used by the application 102, including the executable code for the application 102.

The application 102 can also receive input from the user on the mobile device 104 corresponding to a bird that the user sites in the field. Information corresponding to the sited bird can indicate colors for predefined regions of the bird body that is shown in a selected template. The selected template, for example, can be one of multiple selectable templates, and the indicated colors that the user specifies can correspond to the observed bird. The user can select an option from the user interface of the application 102 to store information to an observed bird file 118 representing the indicated colors for the predefined regions of the bird body. For example, the user may access the stored information later for identification of the observed bird.

In some implementations, the mobile device 104 includes a touch screen that is capable of receiving the input indicating the colors for the predefined regions in various ways. For example, the user may use the touch screen to perform drag-and-drop operations between a location on a color pallet and any location in a predefined region corresponding to an anatomical region of the observed bird that is displayed on the screen (e.g., in a selected one of multiple selectable templates). In some implementations, performing a drag-and-drop operation includes snapping (e.g., automatically filling) the color to the predefined region.

Some implementations of the system 100 include a bird species database system 120. In some implementations, storing information for the observed bird to the observed bird file 118 includes storing the date and time of the siting of the observed bird, the location on Earth where the siting occurred, and information representing the indicated colors of the observed bird. In some implementations, Earth location data can be obtained automatically (e.g., using GPS) from the mobile device 104 and provided in the file along with the information for the date, time and indicted colors of the observed birds.

In some implementations, when the user stores information for the observed bird to the observed bird file 118, the system 100 (or the application 102) can send bird identification information 122 (e.g., in a file) that corresponds to the observed bird to the bird species database system 120 for identification of the observed bird.

The system includes one or more servers 124, which can provide the bird identification application 102 to the user's mobile device 104. For example, the user may request the bird identification application 102 over the network 110 upon observing a bird at a remote location if the user is interested in determining the species of the bird and does not currently have a bird identification application loaded on his (or her) mobile device 104. In some implementations, the identification application 102 can be pre-loaded on the user's mobile device 104 (e.g., at a factory, phone store, computer store, etc.), or the identification application 102 may be downloaded from the Internet using a cable attached to an Internet modem, to name a few examples.

In some implementations, the bird identification application 102 (which can be referred to as the Bird Beat™ Birder's iField Notebook) can automate the sketching and note-taking process as described below. With a preset inventory of bird-shaped templates, the birder can select key features such as body, head, and bill size and shape. By touching and dragging colors from a color bar or wheel, a birder can capture body, tail, wing and head colors. Using pattern tools, the user can add spots, stripes, streaks, etc. to the template. This finished bird topography graphic (e.g., in the form of an observed bird file 118) can be linked with a comprehensive electronic field guide database or bird species database system 120 for identification of the observed bird. In some implementations, licensing agreements can exist with an existing database, such as the Cornell Lab of Ornithology, the National Geographic Society, or a database created specifically for use with the application 102. Upon receipt of the observed bird file 118, a search can be performed to considerably narrow the field of possible matches. In addition, the finished graphic images can be saved, archived, printed, emailed, posted to a tie-in website (e.g., BirdBeat.com) for ID confirmation, and/or shared with other birders 126 (e.g., by posting to social networking sites).

In some implementations, the bird identification application 102 can consist of one or more separate applications that can be provided to execute concurrently (e.g., different applications for different bird types) or in series. For example, a series of applications may occur as upgraded versions/releases provided over time or as differing levels of application service provided for different purchase amounts.

The bird identification application 102 can be used to identify several types of wild birds, including songbirds, backyard birds, waterfowl (e.g., swans, geese, ducks, loons), birds of prey (e.g., hawks, eagles, falcons, owls, vultures), shorebirds and marsh birds, wading birds, seabirds, game birds, regional birds, and world birds (e.g., birds of every nation, continent and region). In some implementations, a premium version of the application 102 can include all of the above, plus the ability to search a predictive database (e.g., the bird species database system 120) for possible identification matches.

In general, the bird identification application 102 (e.g., the Bird Beat™ Birder's iField Notebook) can also allow the bird observer to quickly and easily capture significant field data, including date and time of sighting, weather conditions, behavior, location and habitat. In some implementations, these statistical field notes can help focus the identification process, e.g., by narrowing the search parameters for use with database search functionality. Some of this field data that is captured or input can utilize the mobile device's 104 on-board GPS. Some of this field data can be selected from drop-down menus or keyed in using the device's keyboard or other text input interface (e.g., the touch screen). In some implementations, additional statistical data can be gathered, such as flight patterns, relative flock size, number of birds, distance from birds, and number of observers. In some implementations, such data can be directly uploaded to bird monitoring organization web sites that utilize the information to gather, vet, archive and disseminate bird distribution and migratory patterns to both the public and scientists around the world.

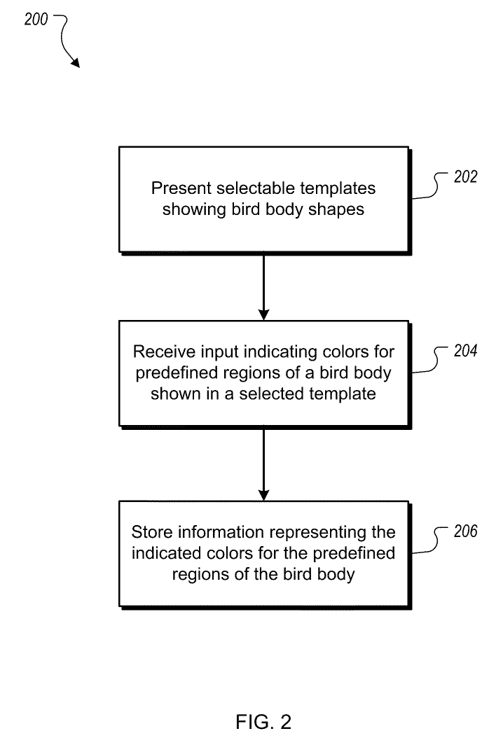

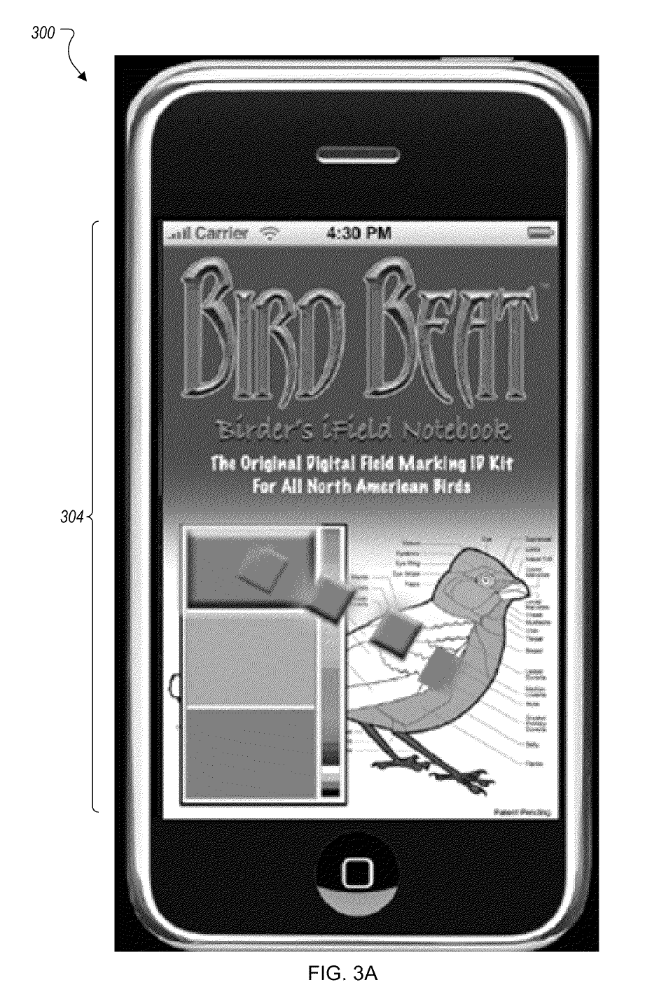

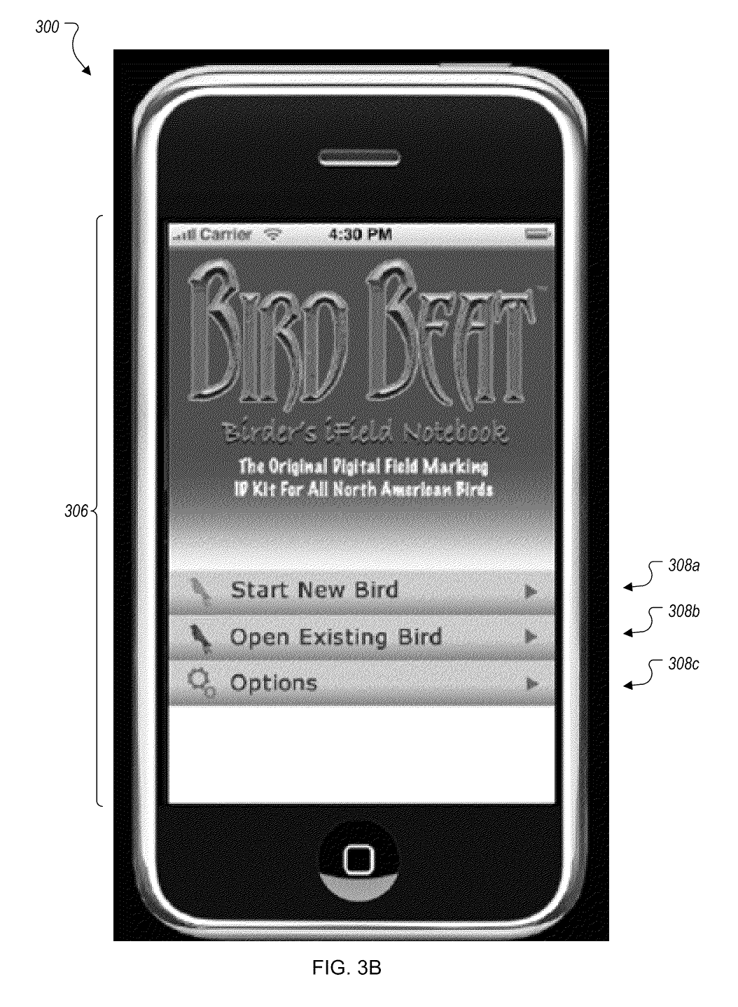

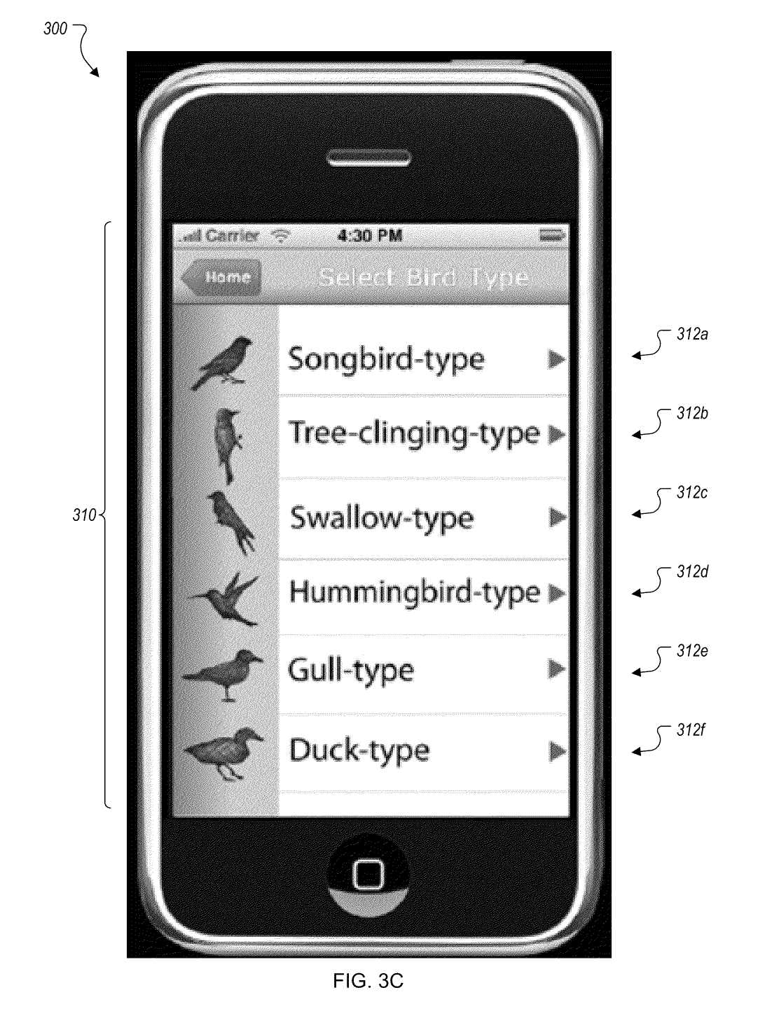

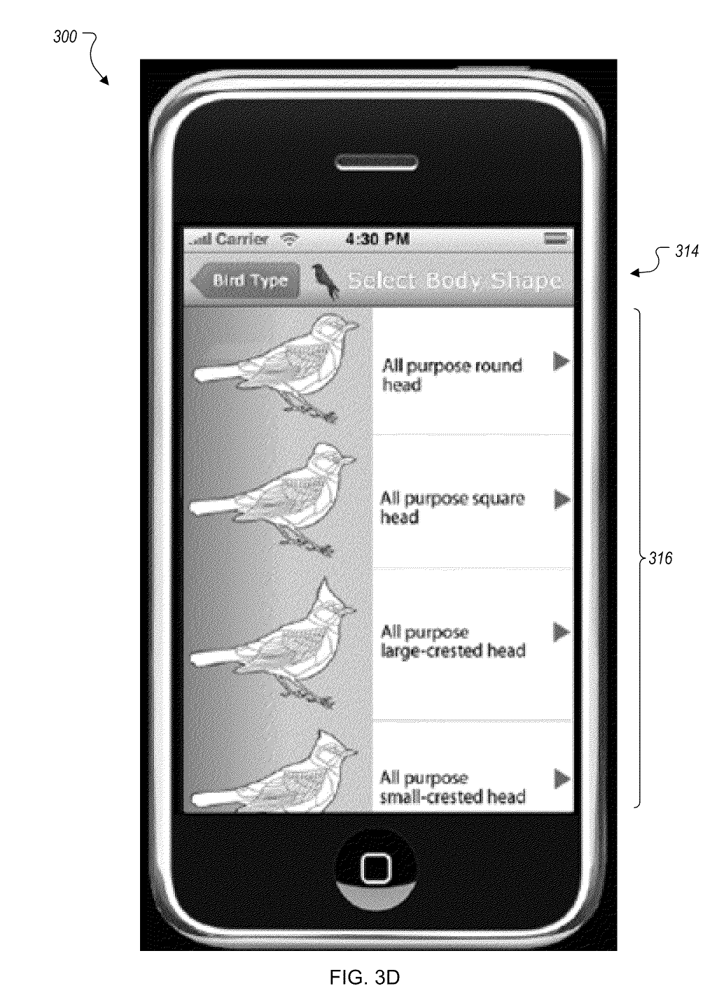

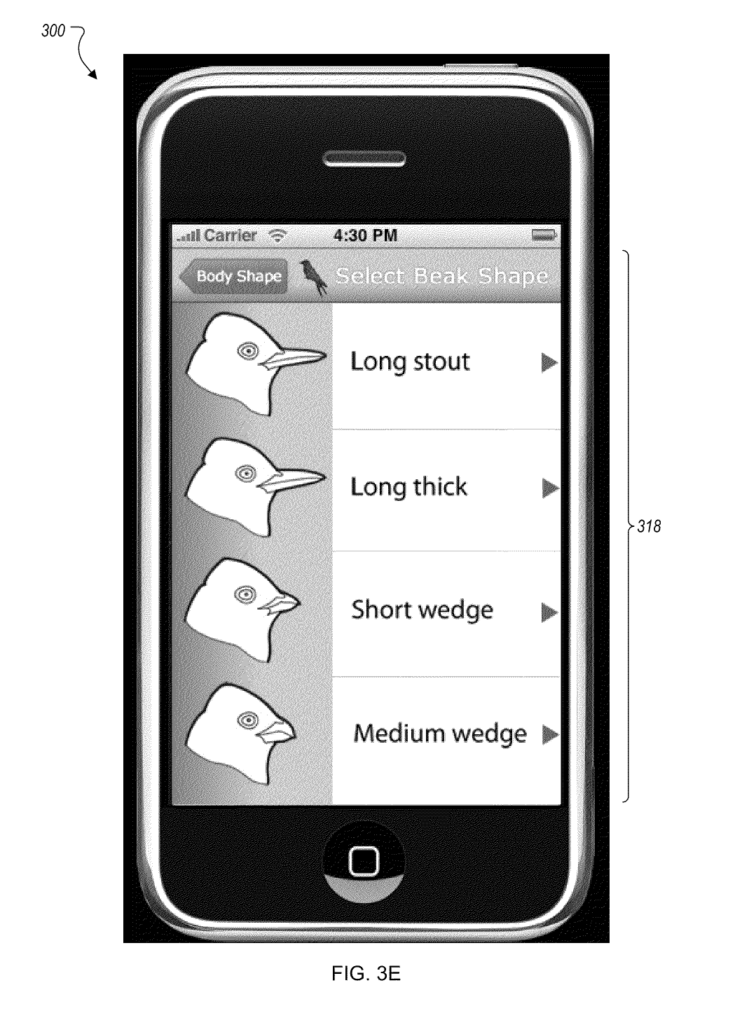

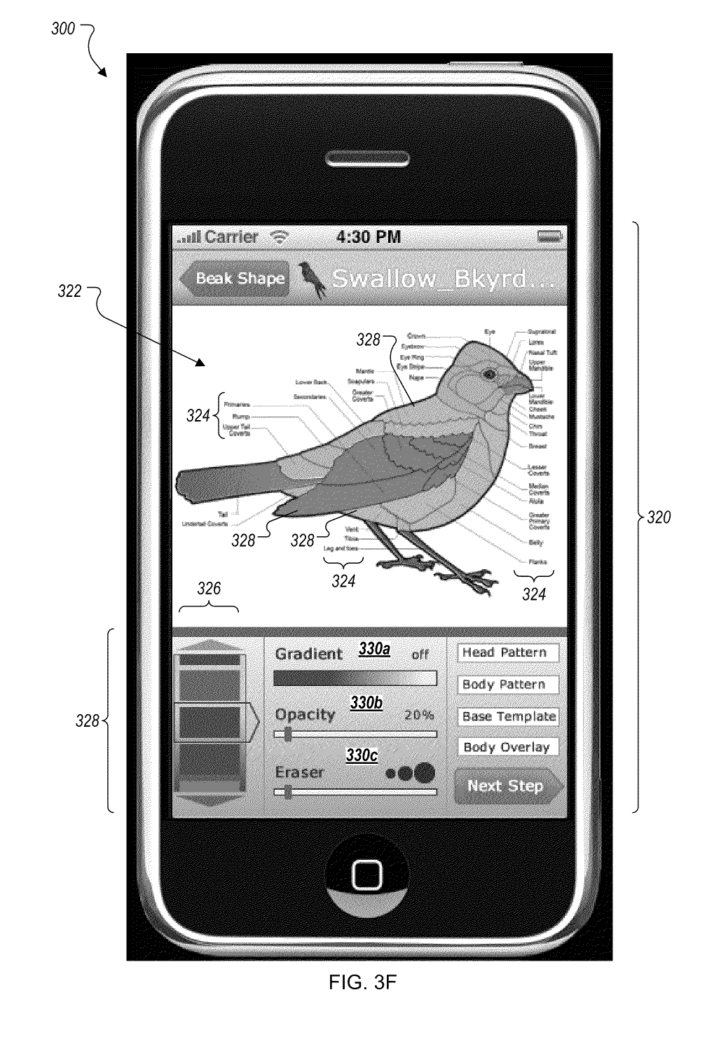

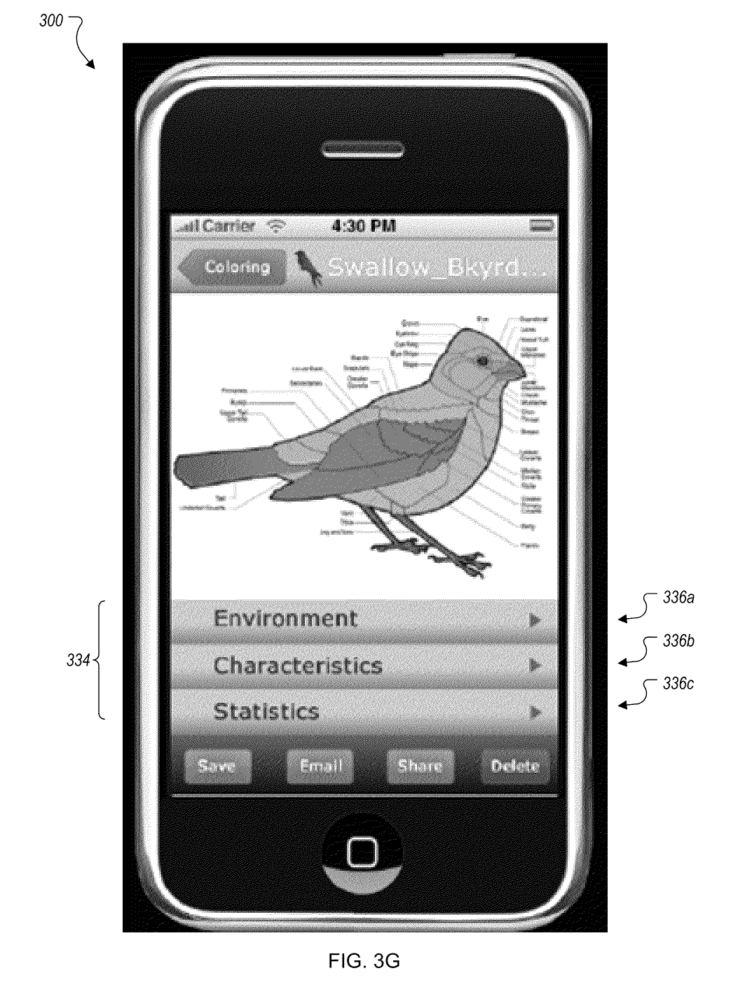

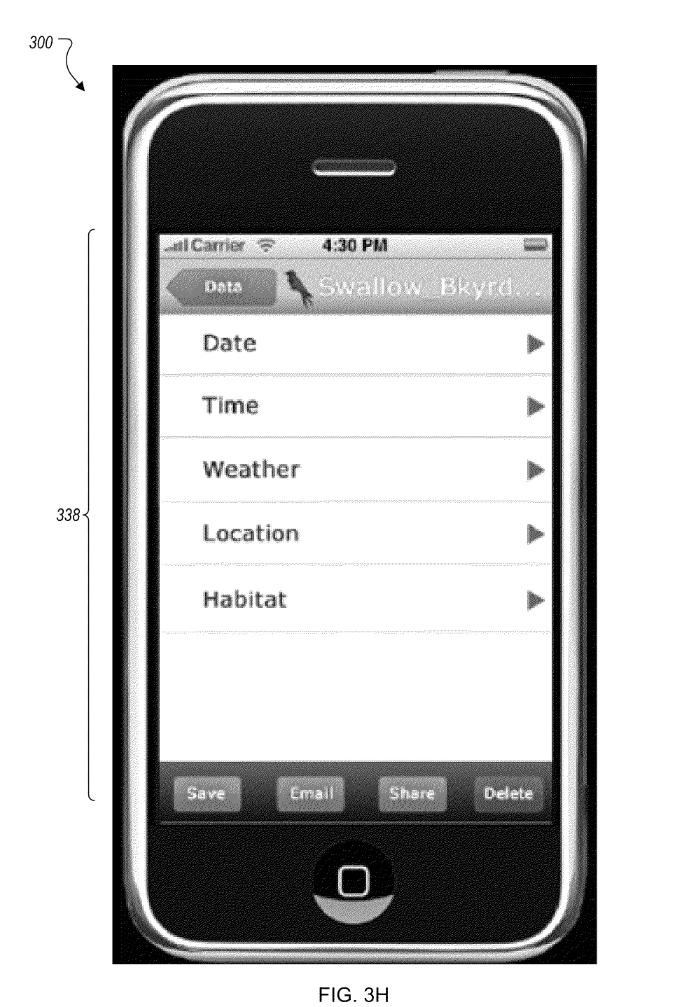

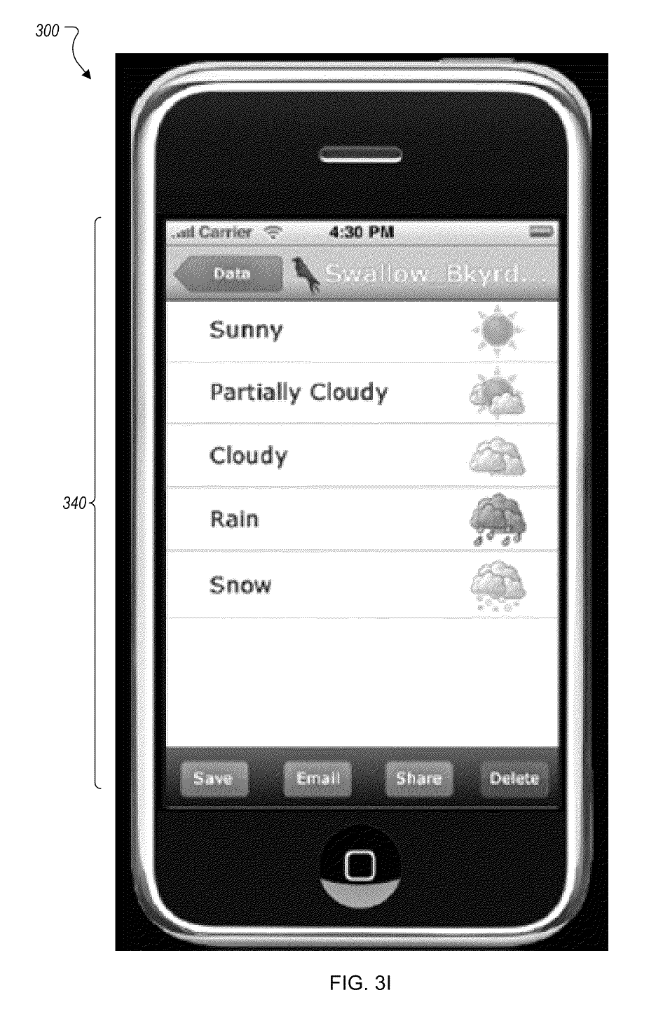

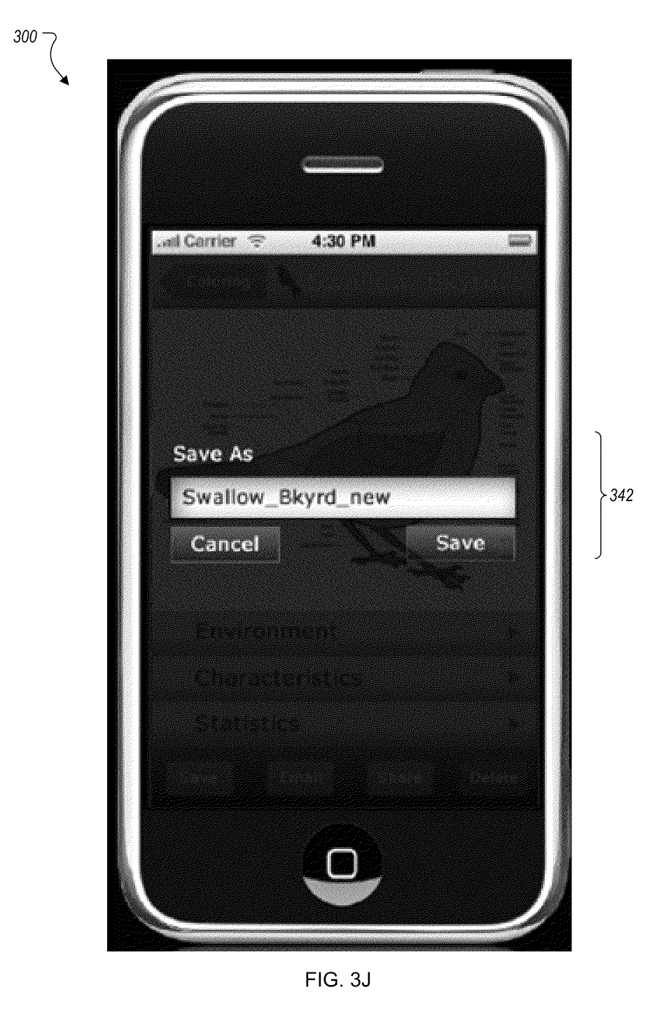

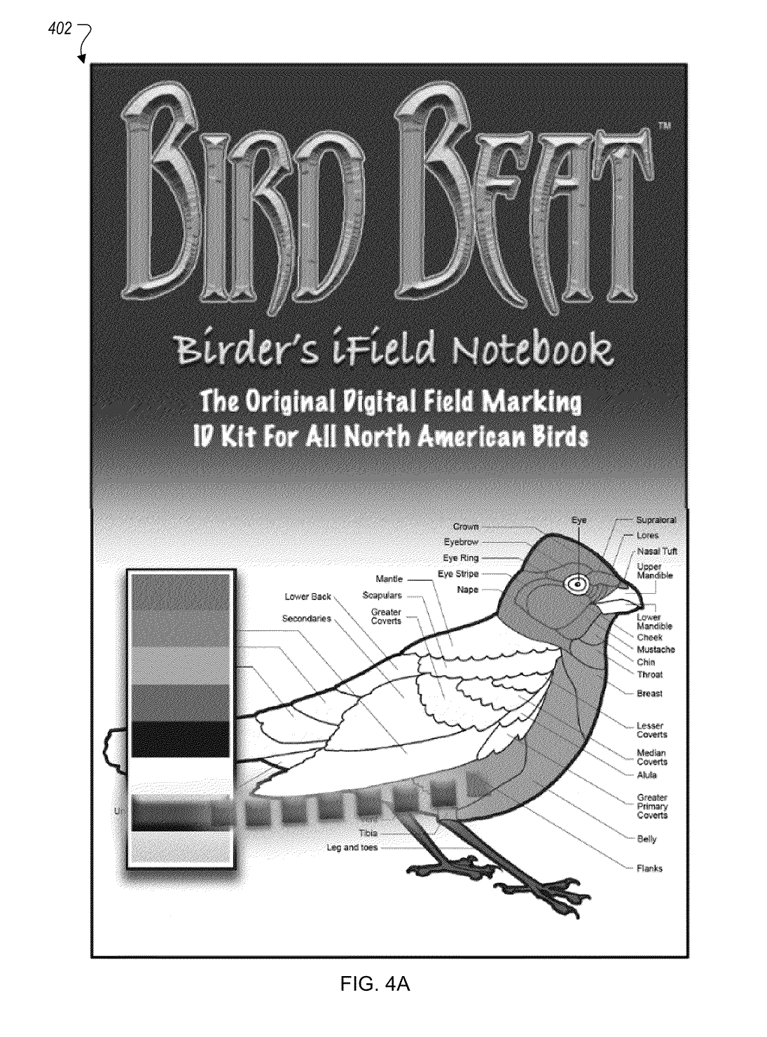

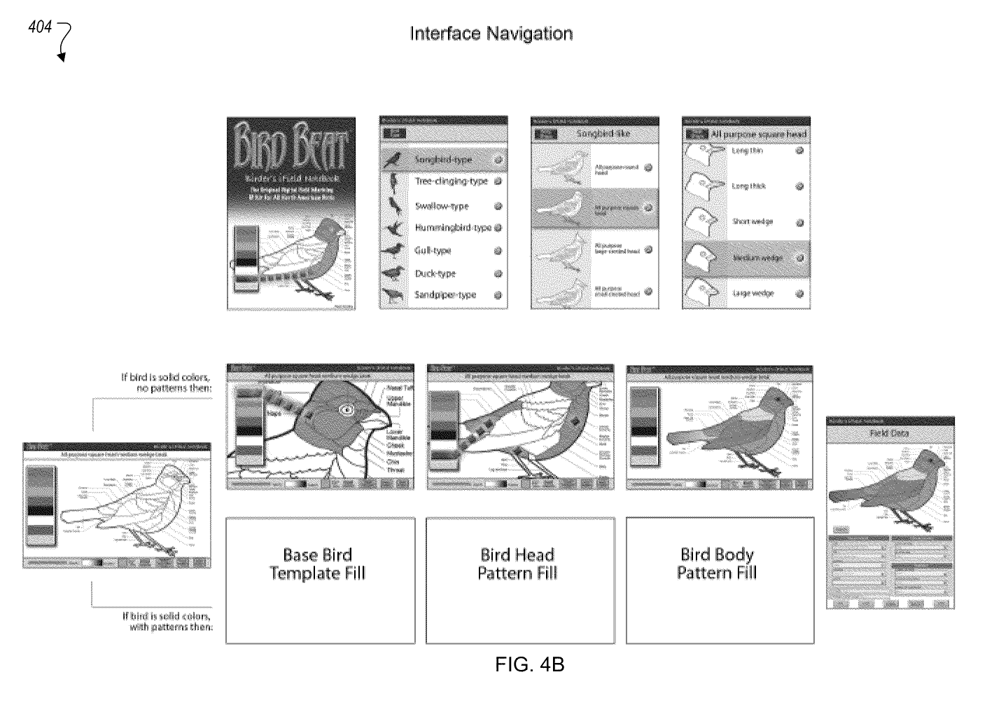

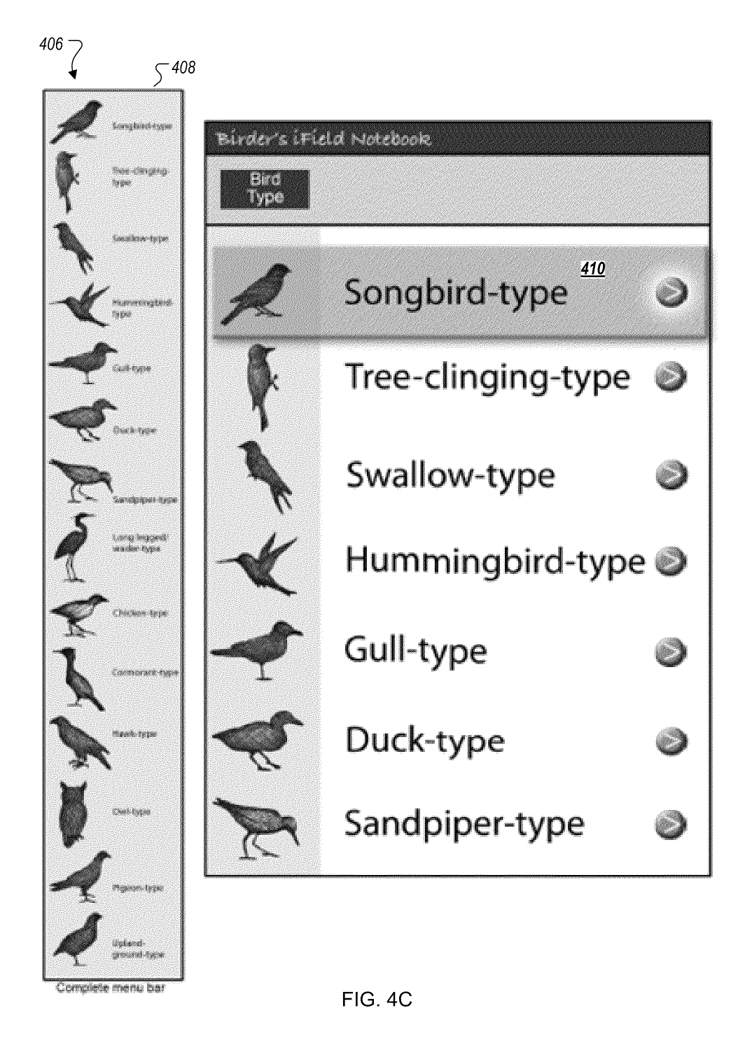

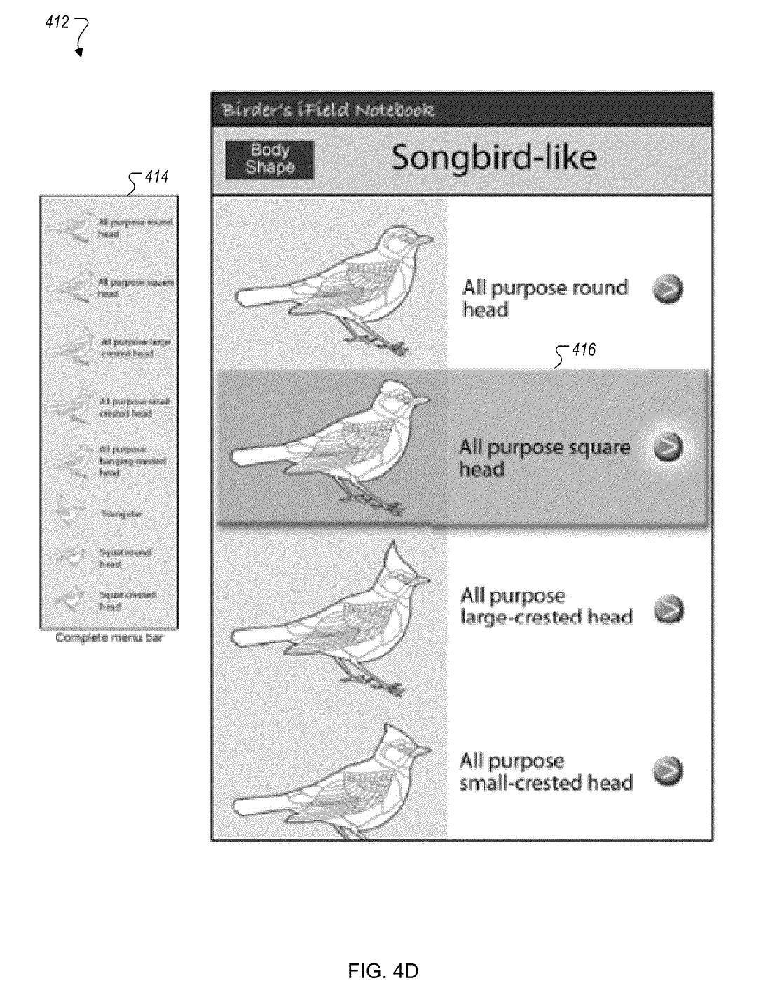

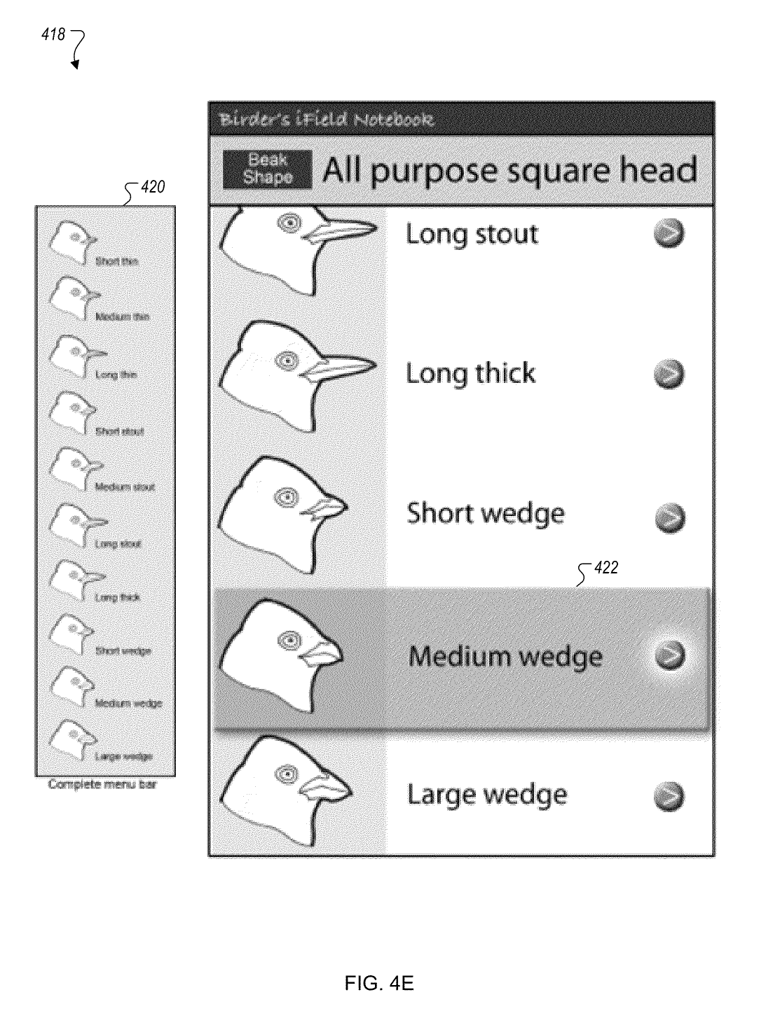

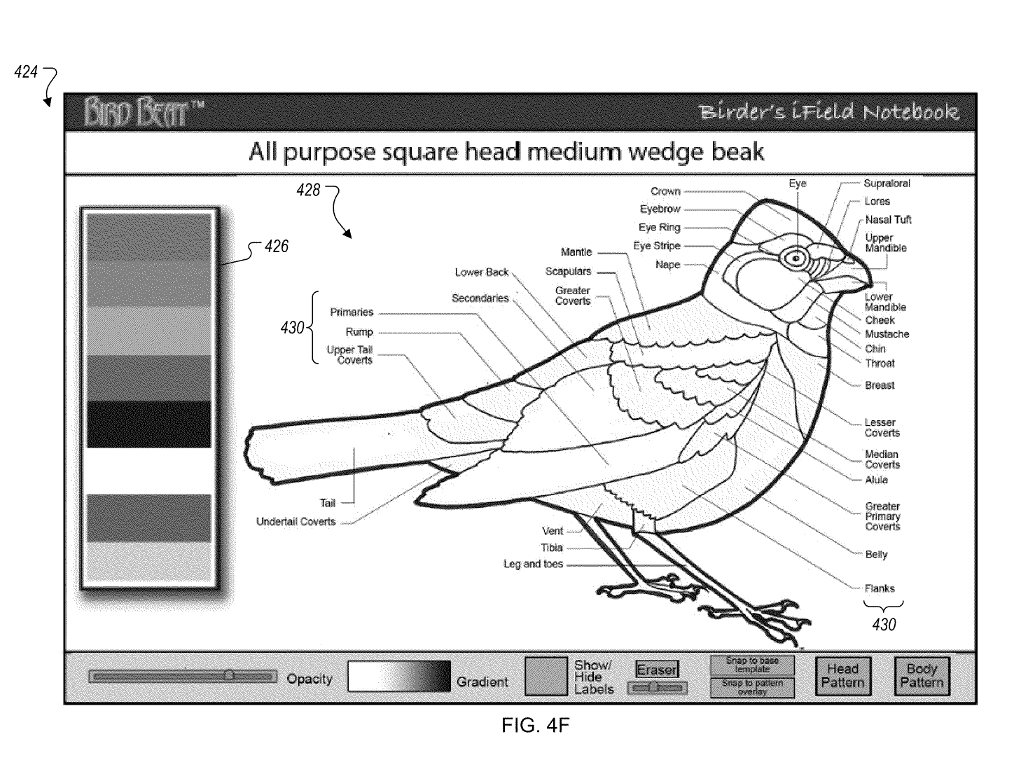

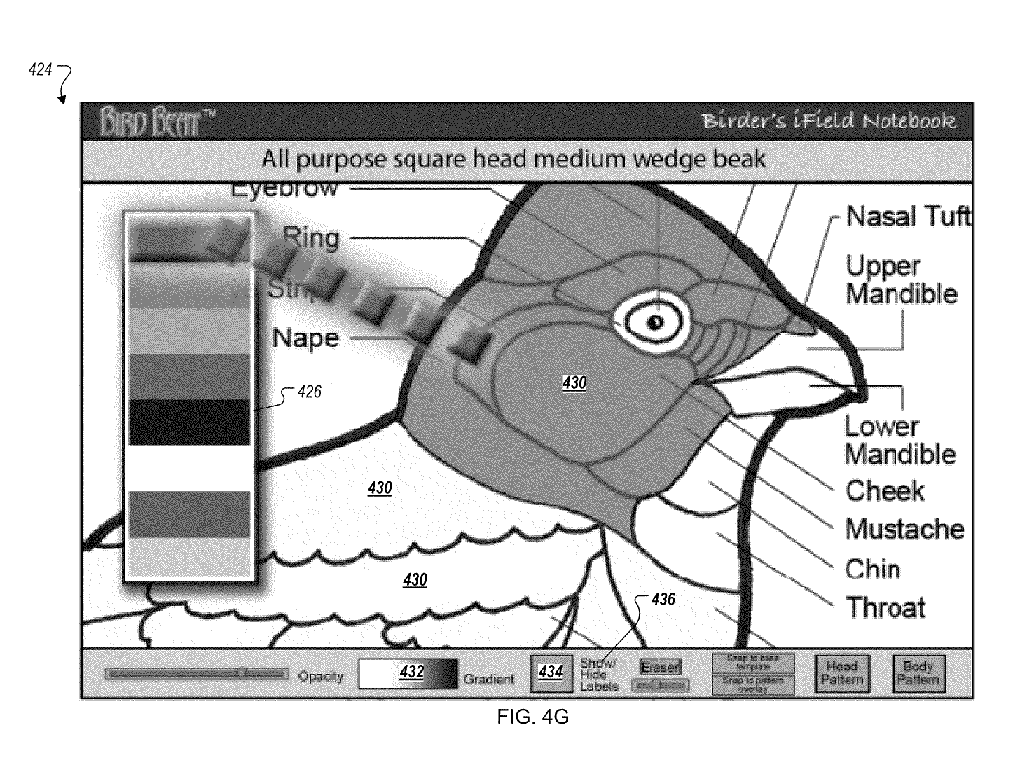

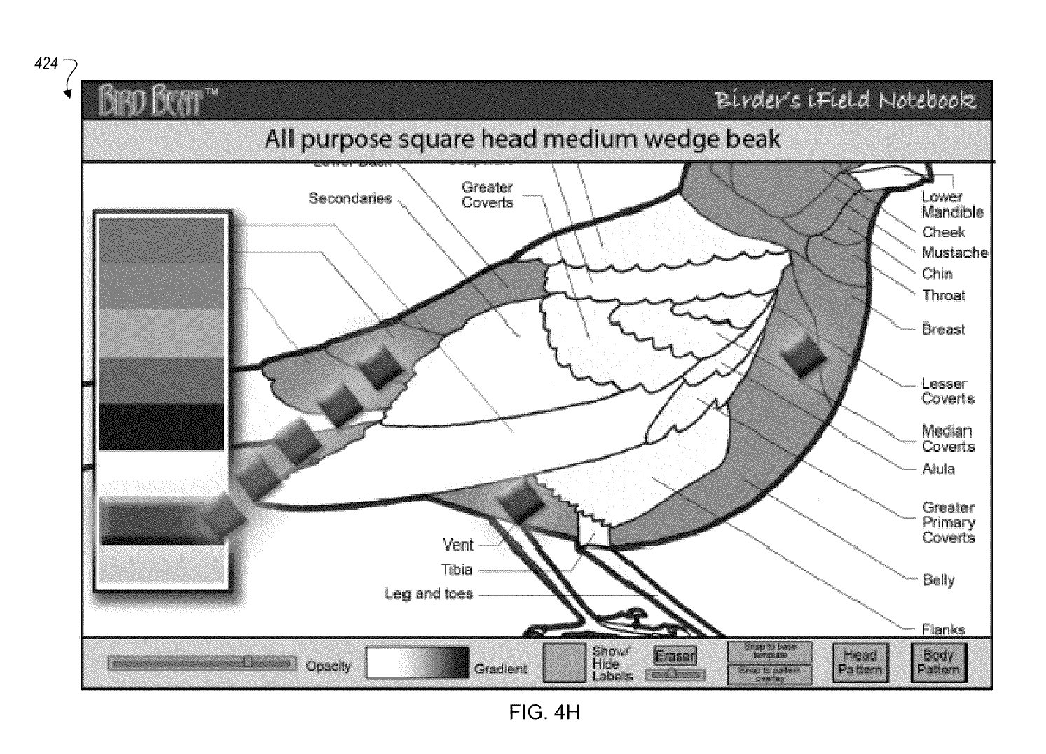

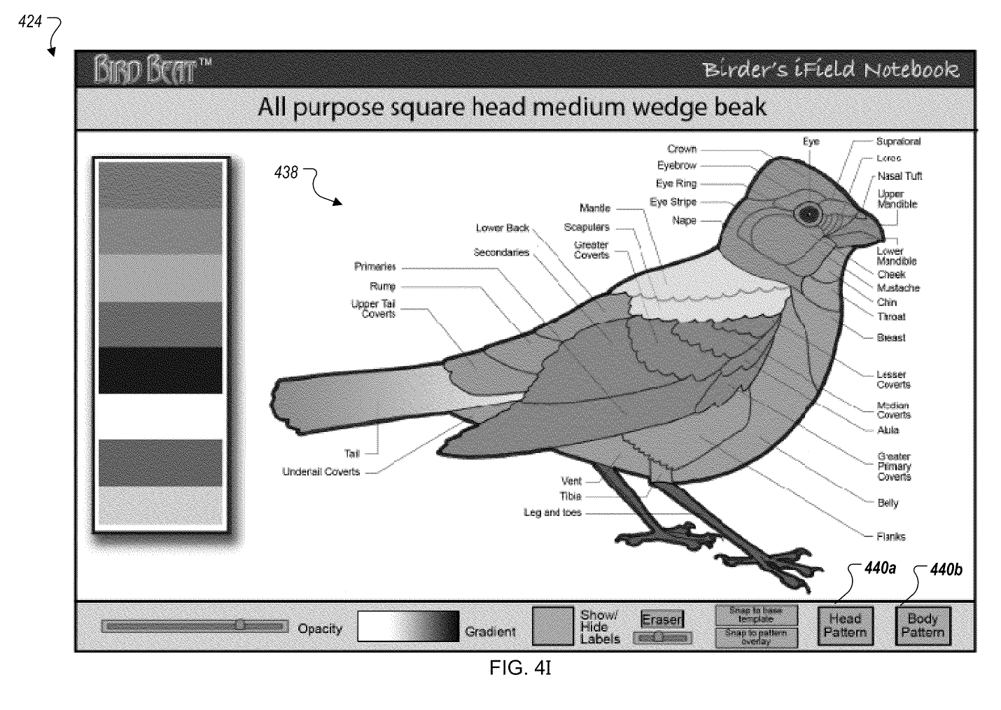

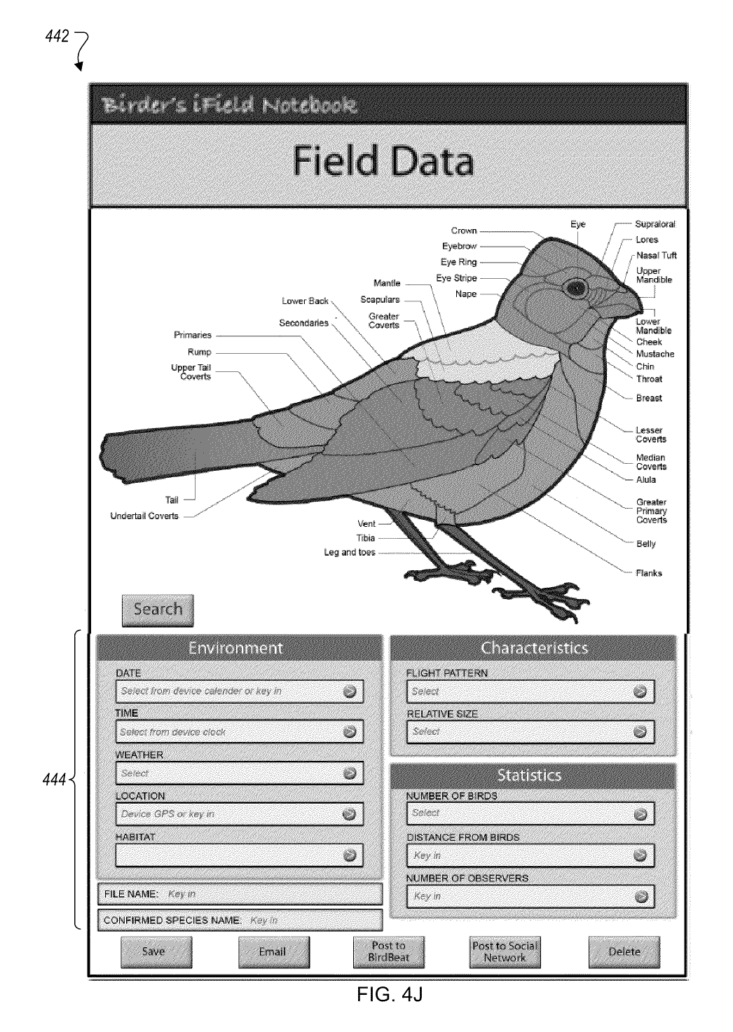

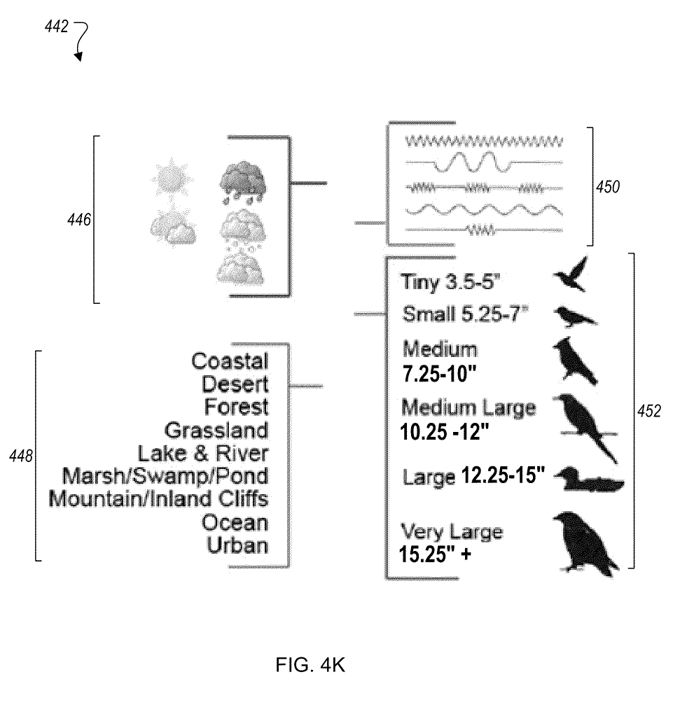

FIG. 2 is a flow chart of an example process 200 for bird identification. For example, the bird identification application 102 can perform the process 200. The description of FIGS. 3A-3J will be used, in part, to describe example implementations of the steps of the process 200. FIGS. 3A-3J show example sequence of screens, for example, that can be used to implement the application 102 on a mobile smartphone. The descriptions of FIGS. 4A-4K, 5A-5H and 6A-6O provide additional examples that can correspond to the steps of the process 200.

Referring to FIG. 2, selectable templates showing bird body shapes are presented (202). For example, a birder may be carrying his mobile device 104 while out in the field on a bird-watching expedition. When the birder observes a bird that he wishes to identify, he (or she) can start (or resume) the application 102. In some implementations, the application 102 can first display a list of general bird categories (e.g., songbirds, birds of prey, etc.). For example, if the birder sees a bird thought to be a songbird, the birder can select the songbird category. In some implementations, the application 102 can provide several more selectable sub-templates on additional screens from which the birder can select shapes for specific bird features including, for example, the head, beak and tail. For example, within the category of songbirds, several head shapes, beak shapes and tails may be possible, each of which (alone or in combination) may result in the display to the user a group of additional sub-templates from which to make a selection. As a result of making selections from available body shapes, the birder can have, displayed on his mobile device 104, a line drawing that represents the bird that the birder is observing. The line drawing can be a template that includes several regions, each region capable of being colored in by the birder to paint the colors for the bird being watched.

For example, as shown in FIG. 3A, from user's mobile device home page, a Bird Beat™ Birder's iField Notebook application 300 is selected. In some implementations, the application 300 can be the application 102 described with reference to FIG. 1. This opens what is known as a “Splash Page” 304. This screen can be visible for a few seconds before an application home page 306 (FIG. 3B) of the application opens automatically.

As shown in FIG. 3B, from the application home page 306, the user can: a) create a new bird template by selecting a “Start New Bird” button 308a, b) open a previously created bird template by selecting an “Open Existing Bird” button 308b, or c) see other options (e.g., template options) by selecting an “Options” button 308c.

As shown in FIG. 3C, the selection of the “Start New Bird” button 308a opens to a “Select Bird. Type” page 310. The user can scroll through the various bird type options 312a-312f (e.g., Songbird-type 312a) and select the one that most closely matches the bird being watched, viewed or sighted.

As shown in FIG. 3D, upon selecting the Bird Type (e.g., Songbird-type 312a), the user can begin the process of custom building a bird template. A pre-set number of bird topography template parts can be available for every bird type, including body and head size and shape, beak, and tail shapes. The user is able to select from these in the process of custom building an entire bird topography map that can be filled in with color and pattern features. In the example shown, the user is continuing to define a body shape 314 and is selecting a head type 316.

As shown in FIG. 3E, after selecting the bird body type, the user is directed to subsequent screens to select beak size and shape and tail size and shape. In the example shown, the user is selecting a beak shape 318, completing the black-and-white template for the selected songbird.

Referring again to the process 200 of FIG. 2, input is received that indicates colors for predefined regions of a bird body shown in a selected template (204). As an example, in this step, the user can fill in colors for each of the regions of the black-and-white template selected in step 202. In a step-by-step process, the template can be transformed into a likeness of the bird that the user is observing.

For example, as shown in FIG. 3F, after building the finished bird topography map, the user is taken to the color and pattern page 320. A bird topography map 322 (or template 322) is labeled with the universally accepted feather grouping labels 324. The user has the option to show or hide the feather grouping labels 324. By providing the feather grouping labels 324, the user has both a learning device as well as an observational device.

From a preset palette of hexadecimal web colors 326 on the left side of a tool bar 328, the user can scroll through the color wheel and choose colors to touch and drag to the bird template. The colors can snap to fill in whatever outlined area 328 to which the user drags the color. The size of the template 322 can be controlled with the “pinch and zoom” technology of the touch device so that even smaller template areas 328 can be easily filled with color. Colors can be further controlled by the use of opacity, gradient and eraser bars 330a-330c in the center of the bars. The eraser tool 330c can be used to either snap-erase an entire section or as an autonomous eraser not bound by template boundaries. On the right side of the tool bar 328, the user can select streak, spot, and stripe pattern tools to further refine the final image.

As shown in FIG. 3G, once the bird image is complete, the user has the ability to enter additional field data 334 from the time of the sighting. In the “Environment” category 336a, the user can enter the date, time, weather, location, and habitat. This information can be selected from menus, searched by the device's on-board GPS, clock and calendar, or manually keyed in.

In the “Characteristics” category 336b, the user can enter flight patterns, relative size, behavior information and other relevant species specific data that is used in narrowing the number of identification possibilities.

In the “Statistics” category 336c, the user can capture a deeper level of data such as the number of birds (if seen in a flock), distance from bird, number of observers, and other information that could be useful to bird tracking organizations that gather and vet bird sighting data from millions of birders worldwide.

FIG. 3H shows an example “Environment Data” screen 338. FIG. 3I shows an example “Weather” screen 340.

Referring again to FIG. 2, information that represents the indicated colors for the predefined regions of the bird body is stored (206). For example, as shown in FIG. 3J, the user can save 342 the image and field data. This file can then be emailed, uploaded to the Bird Beat™ web site, and/or posted to any of several social networks where the user may now enlist the aid of millions of birders worldwide in confirming a positive bird identification.

FIGS. 3A-3J show an example basic version or implementation of the application 102 on a mobile smartphone. In a premium version or implementation, the user can search a predictive, photographic database of birds for ID confirmation.

FIGS. 4A-4K show example screens that can be used to implement the application 102. FIG. 4A shows an example Home Screen 402 of a bird identification application that, in some implementations, can be the application 102 described with reference to FIG. 1. FIG. 4B shows an example Interface Navigation 404.

FIG. 4C shows an example bird type screen 406 which consolidates the many bird types into fourteen (14) different basic categories 408. From the home page the user is auto-directed to the bird type screen and scrolls to select the basic bird type from the fourteen options. In this example, “Songbird-type” 410 has been selected and the user is auto-directed to the screen to select a songbird body shape.

FIG. 4D shows an example Body Shape screen 412 which consolidates the body shapes of over 500 passerines (songbirds) into eight (8) different shape graphic templates 414. In this example, the “All Purpose Square Head” option 416 has been selected, and the user is auto-directed to a screen to select a beak shape.

FIG. 4E shows an example beak shape screen 418. Each of the eight (8) different songbird body shapes 414 on the previous screen (FIG. 4D) has its own selection of corresponding beak shapes 420. In this example, a “Medium wedge” beak shape option 422 has been selected, and the user is auto-directed to a screen that now contains a complete graphic outline of the body, head and beak of the bird being identified.

As shown in FIG. 4F, when the beak shape is selected, the user is auto-directed to a screen 424 with a color wheel 426 and the completed bird graphic map 428. The image can be displayed in portrait or landscape view. The screen 424 can be stylized to include standard bird topographical (or topical anatomy) markings in such a way that the user can touch colors from the color wheel 426 and drag to each outlined area of the bird map 428. By providing written labels 430 for each area the user also has the opportunity to learn the standard ornithological vocabulary universally used to describe bird markings. Colors in a palette can be determined and can include every color needed to accurately indicate true bird color markings.

As shown in FIG. 4G, the pinch and drag technology of the device allows the user to zoom in and out of specific areas to target smaller and larger template areas 430. Colors can be selected by scrolling up and down the color wheel 426. When the desired color is appears in the wheel 426, the user can touch and drag it from the color wheel 426 to fill single or multiple outline areas 430. Colors automatically snap to fill each outlined area 430. Individual colors and color areas can be modified with an opacity bar 432, which controls the degree of density versus transparency of the color, and with a gradient button 434 which creates a graduation from darker to lighter (or vice versa) in any direction to replicate a blending effect. Labels can be displayed or hidden with a “show/hide” button 436.

As shown in FIG. 4H, the user can move back and forth between the color wheel and the bird template, pinching and zooming and filling areas with color until the image is complete.

As shown in FIG. 4I, the user has a finished color marking map 438 of the overall colors of the sighted bird. In this example, these colors complete the map and the user is able to compare this graphic with any field guide and identify this bird, for example, as a Painted Bunting. However, another type of bird may have additional pattern markings like stripes, streaks, spots, etc. that can be added by selecting the head and body pattern buttons 440a and 440b in the menu bar. These can auto-direct the user to screens providing additional feature option templates.

As shown in FIG. 4J, using a field data screen 442, the user can enter or select fields 444 from the time of the sighting. This feature can make use of the device's on-board clock calendar and GPS for date, time and location information. The field data screen 442 can also provide option lists for other relevant data such as weather, habitat, flight patterns and relative bird size. Statistical data can be keyed in for a deeper level of data capture. The user can save the image and the field data, give it a file name, and once an ID is confirmed, can enter the species name. The image and/or data can be emailed, uploaded to the Bird Beat's web site, posted to social networks, or deleted.

As shown in FIG. 4K, for corresponding fields 444 on the field data screen 442, the user can select from graphic icons 446 to specify the current weather conditions, a list 448 to specify the type of region, an option chart 450 to select a type of flight pattern, and size options 452 to select a general size of the bird.

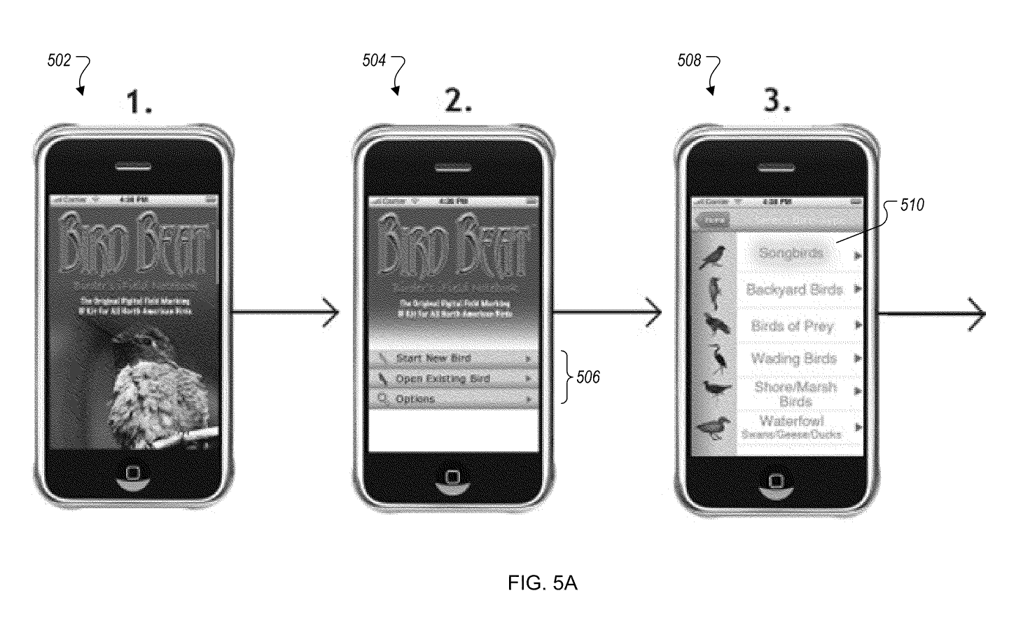

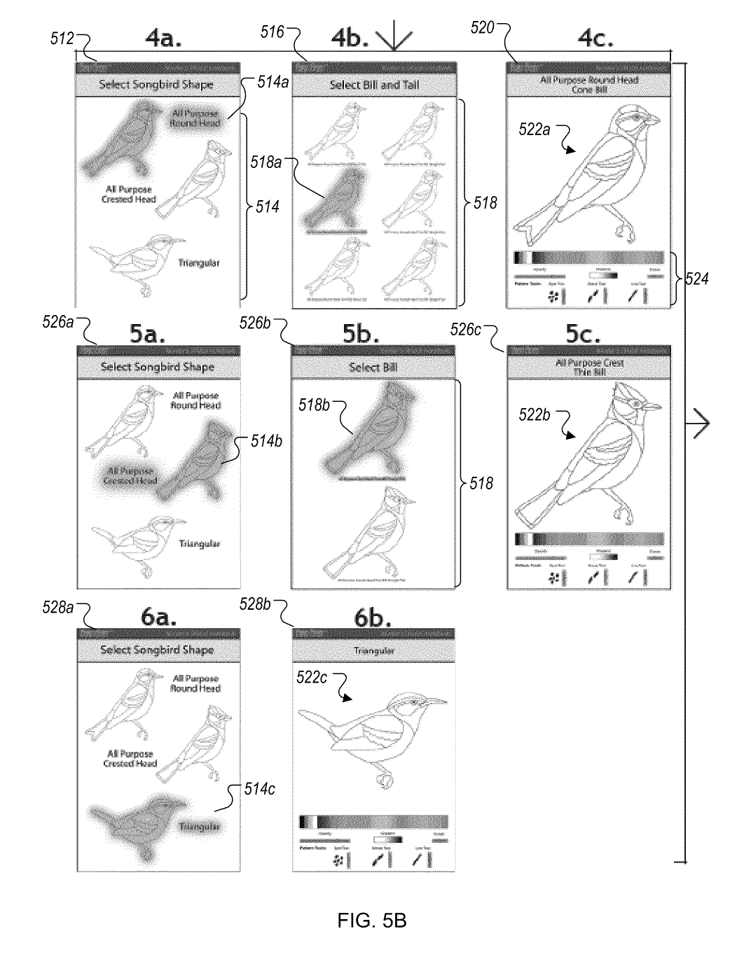

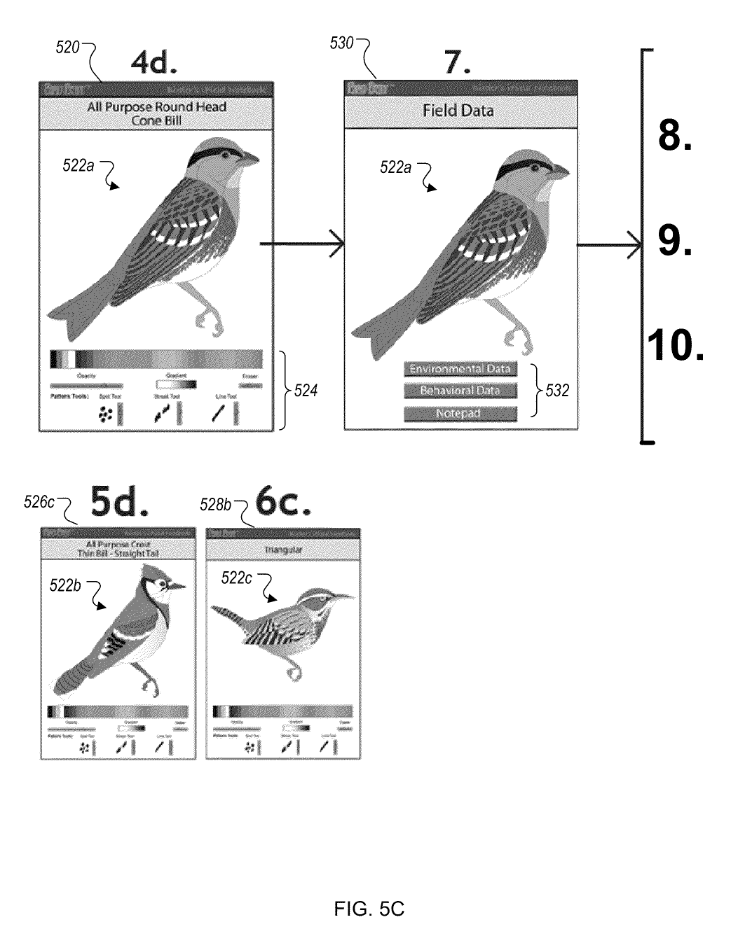

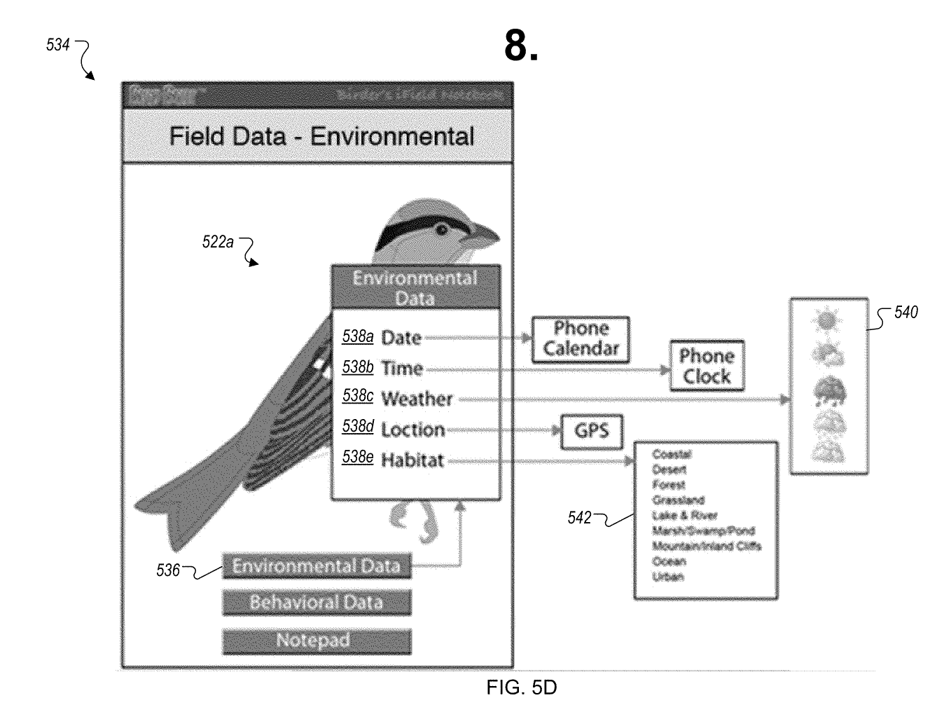

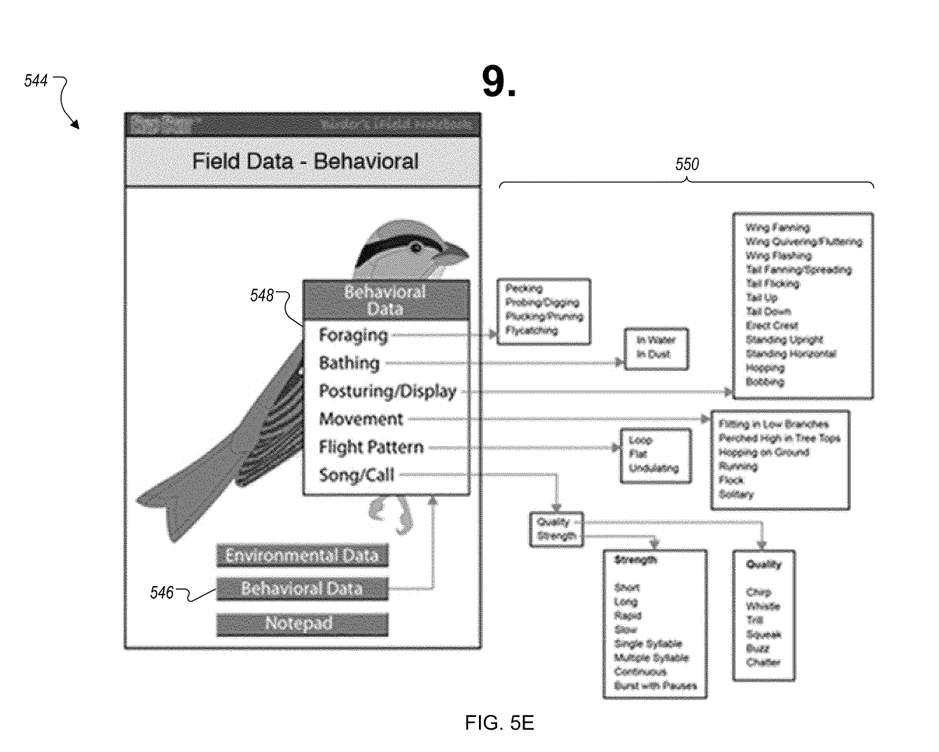

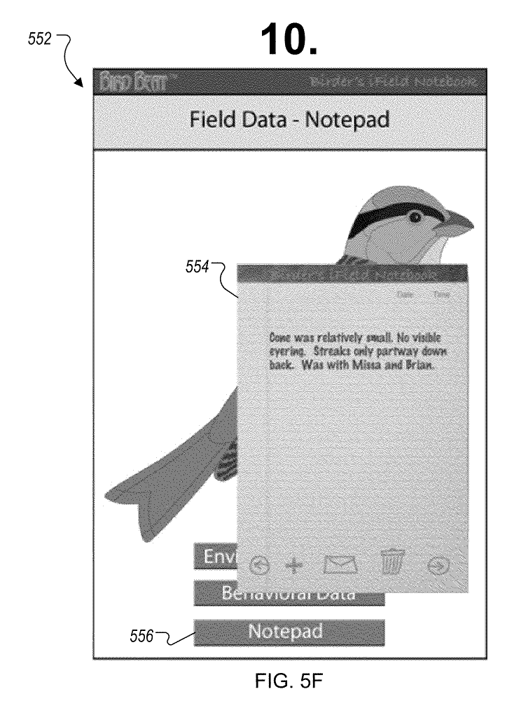

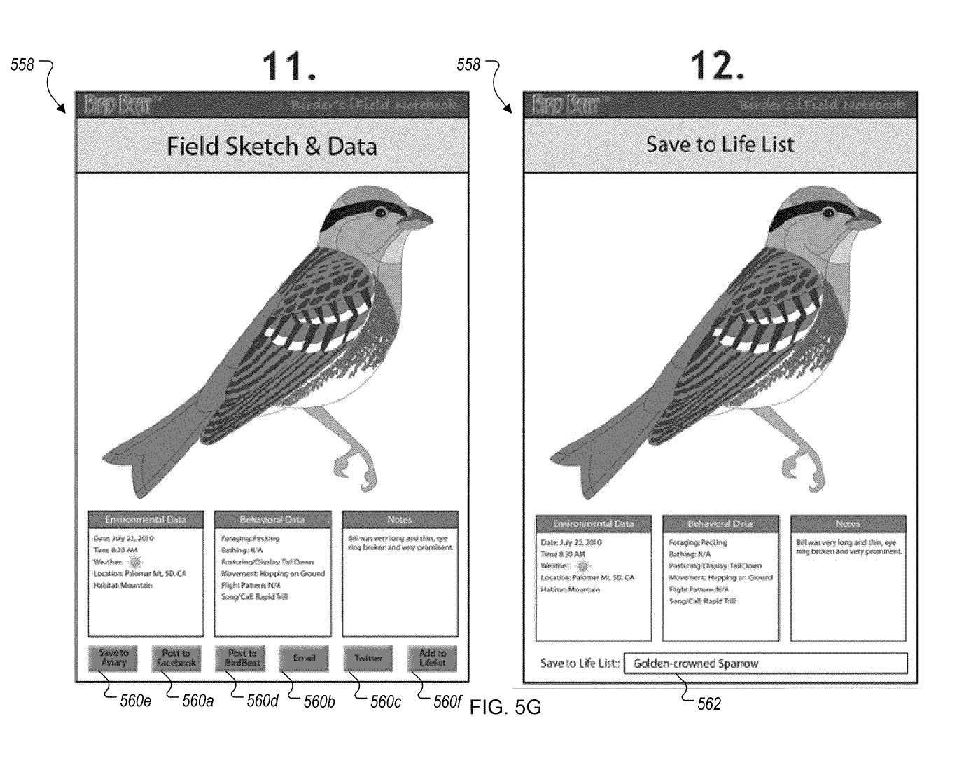

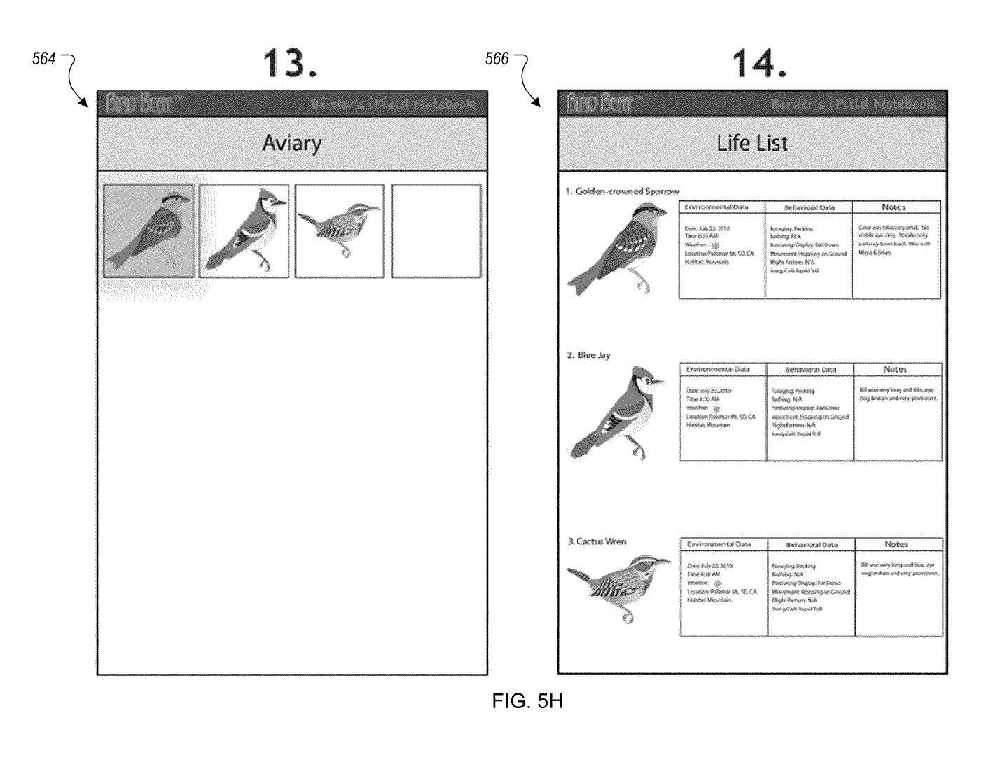

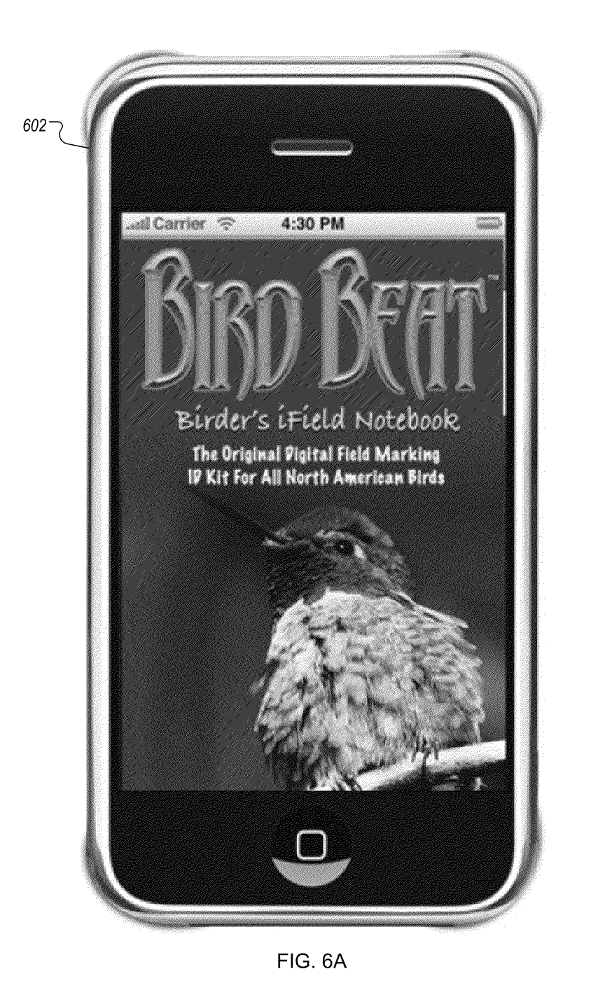

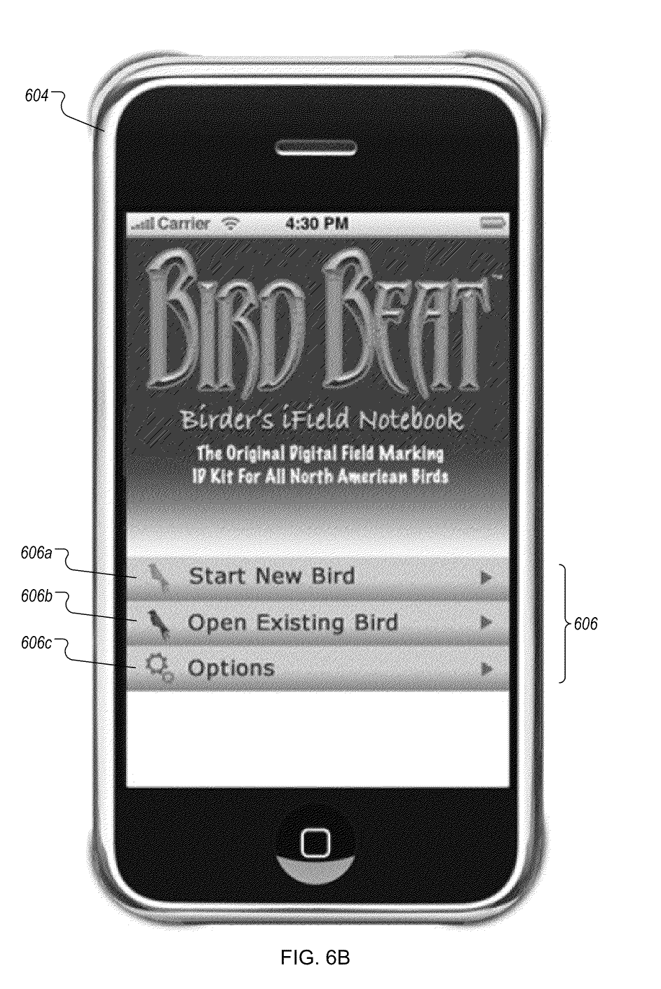

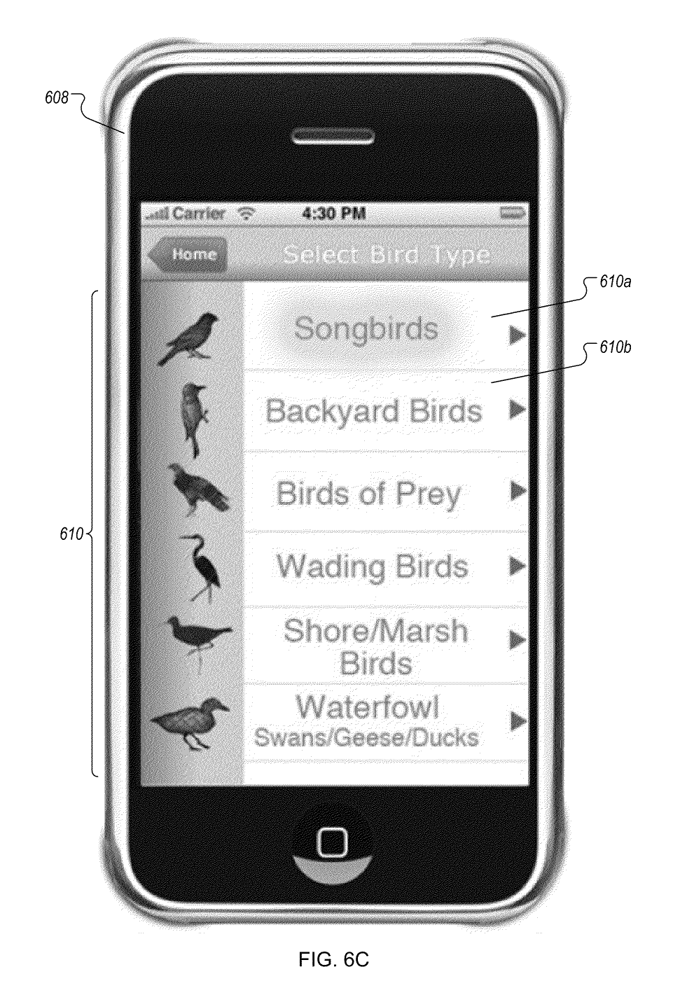

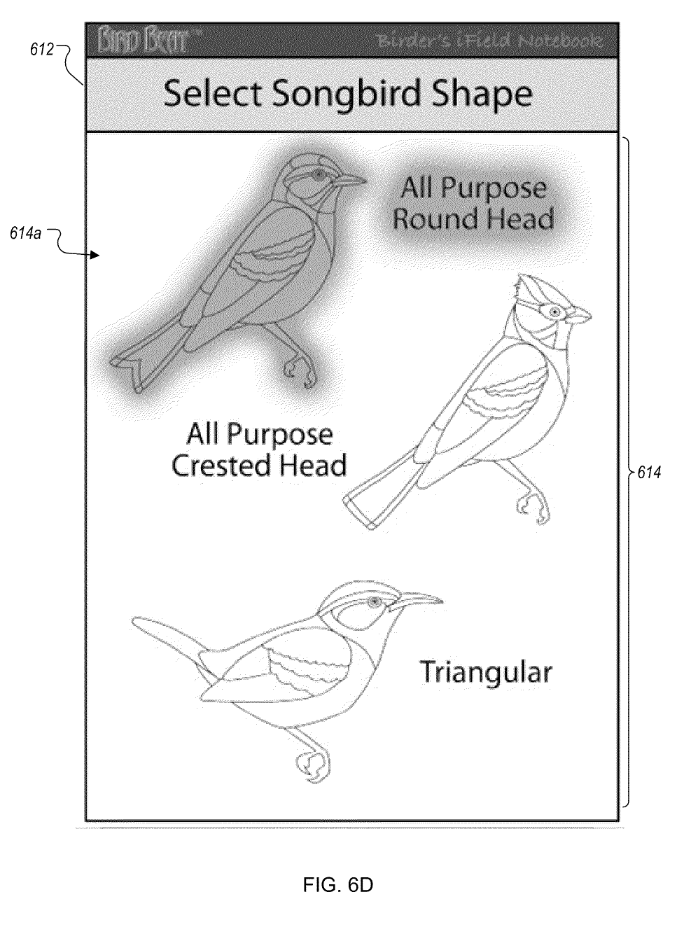

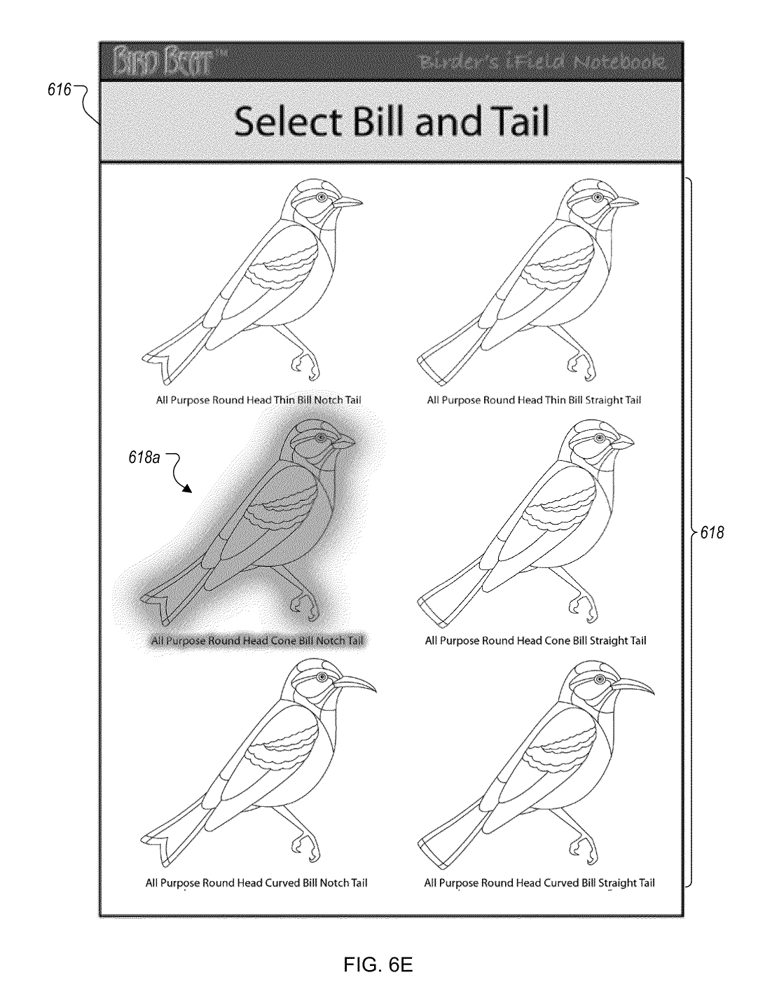

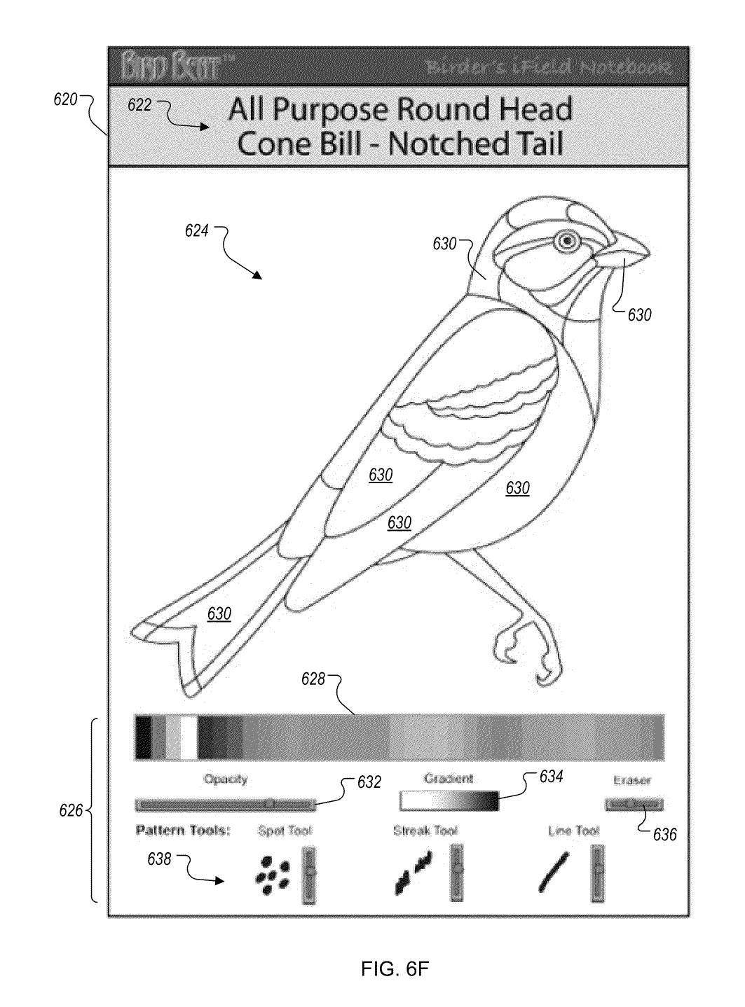

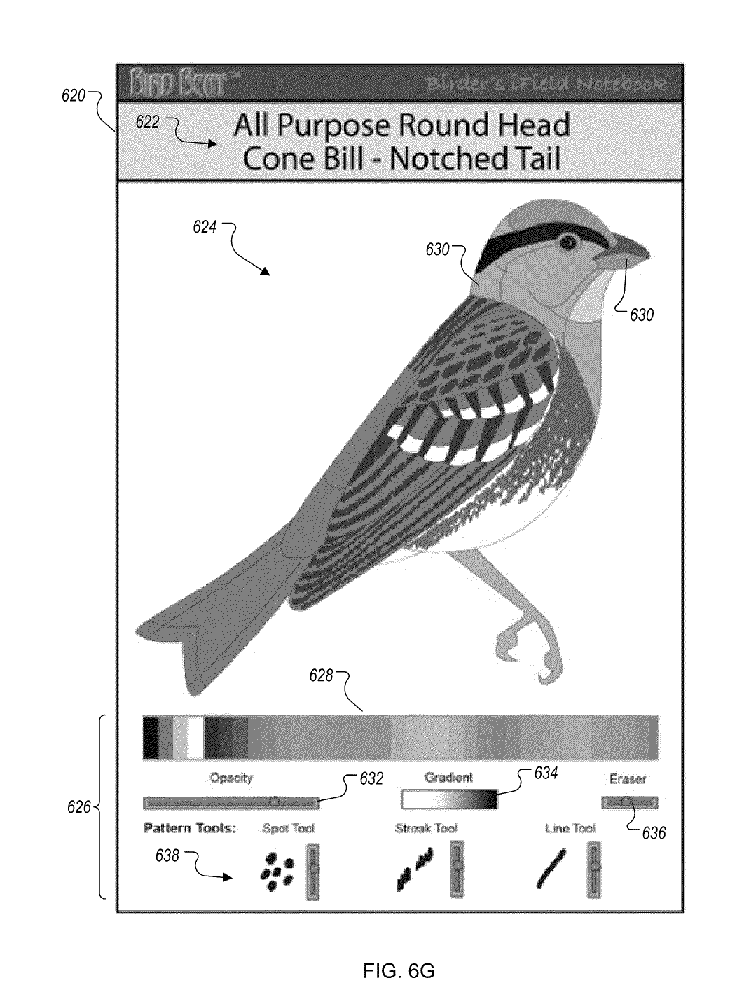

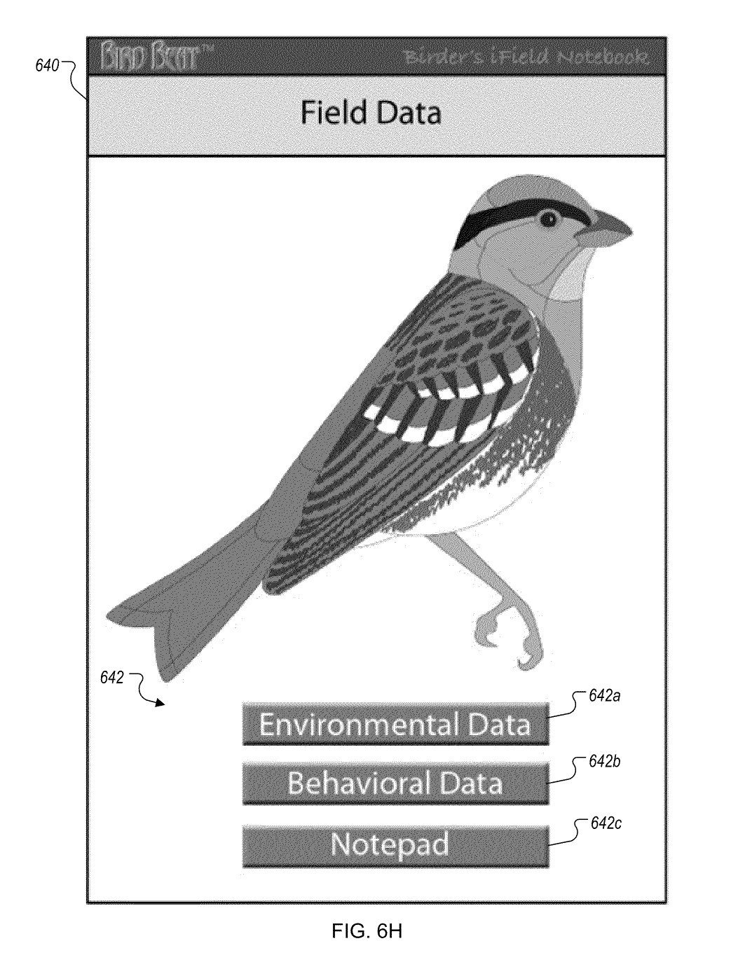

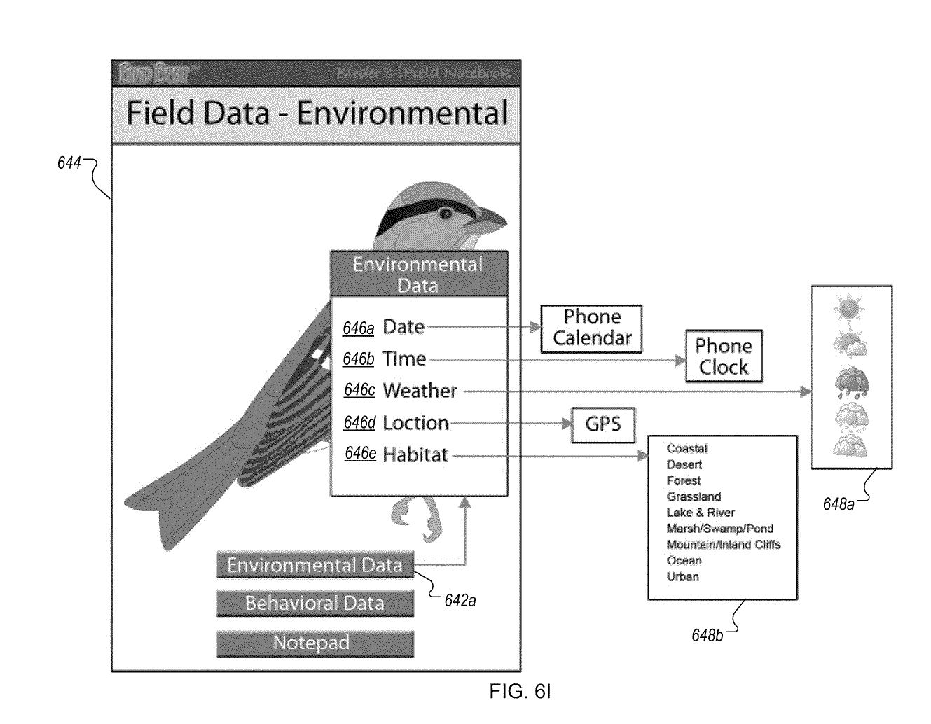

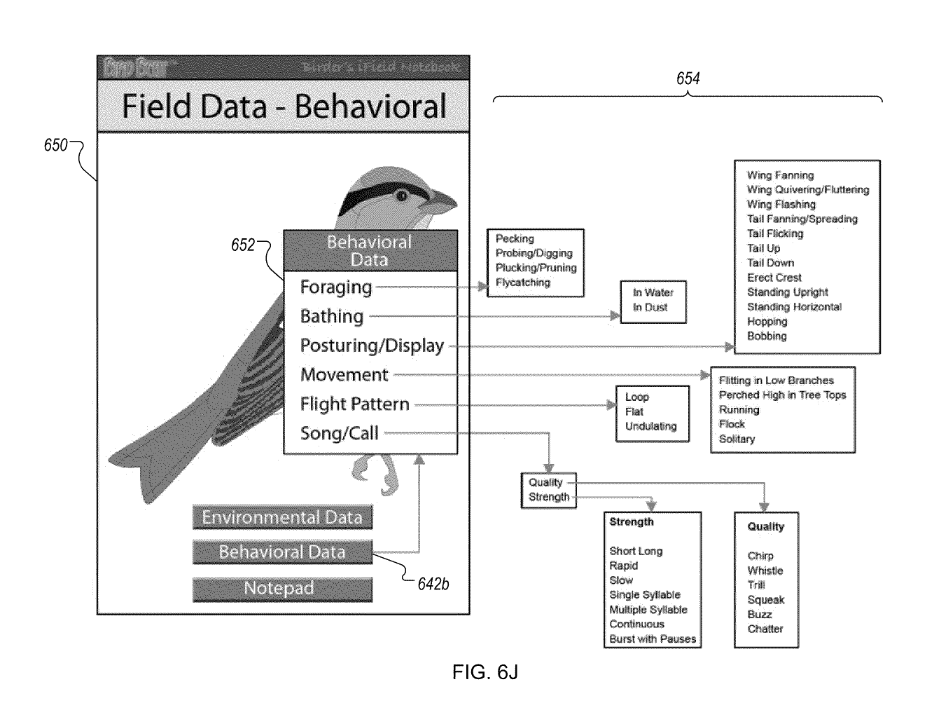

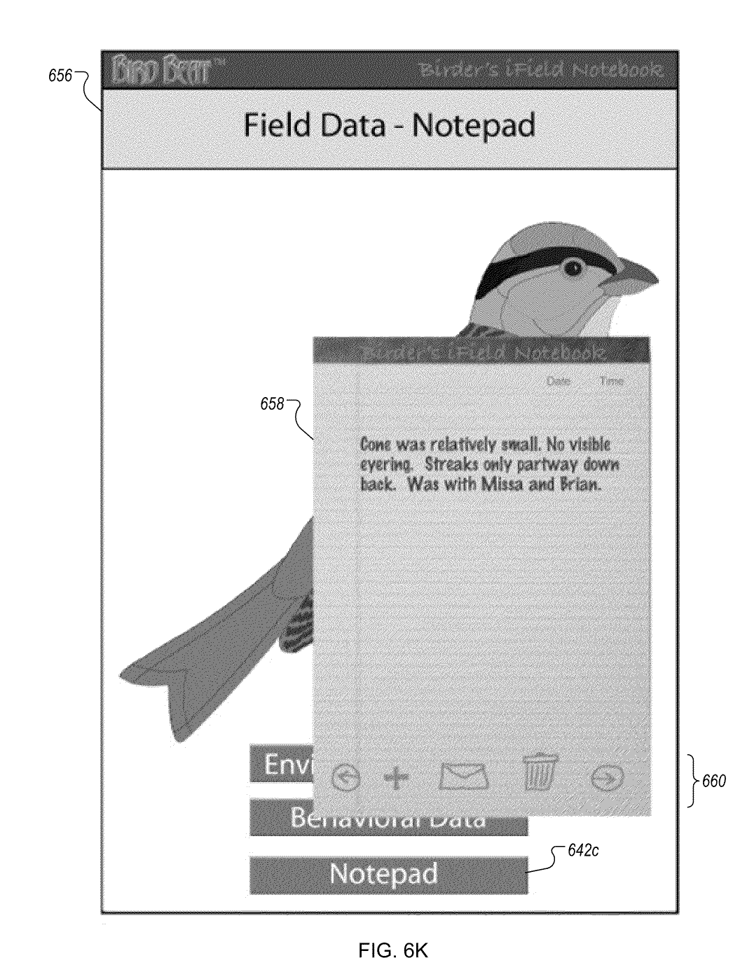

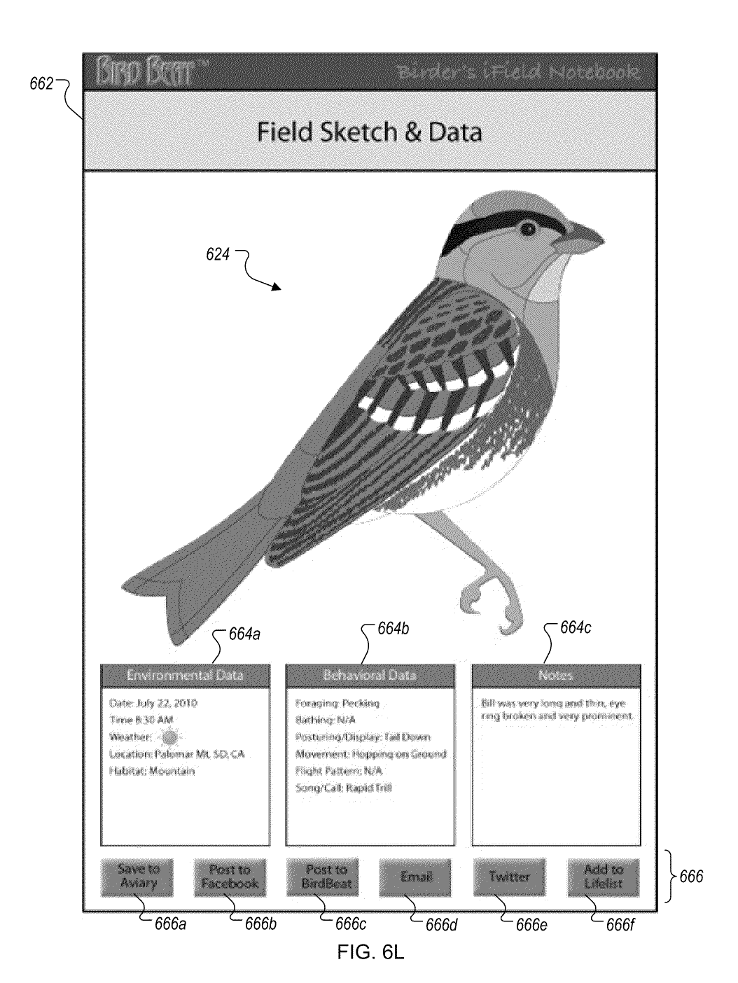

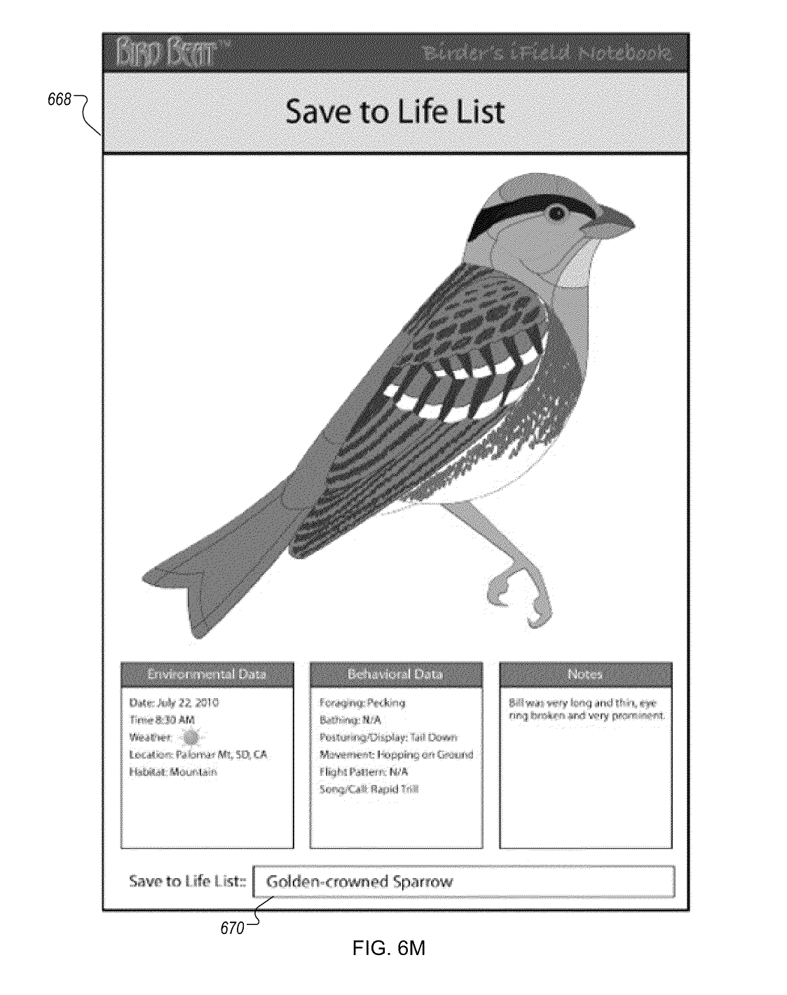

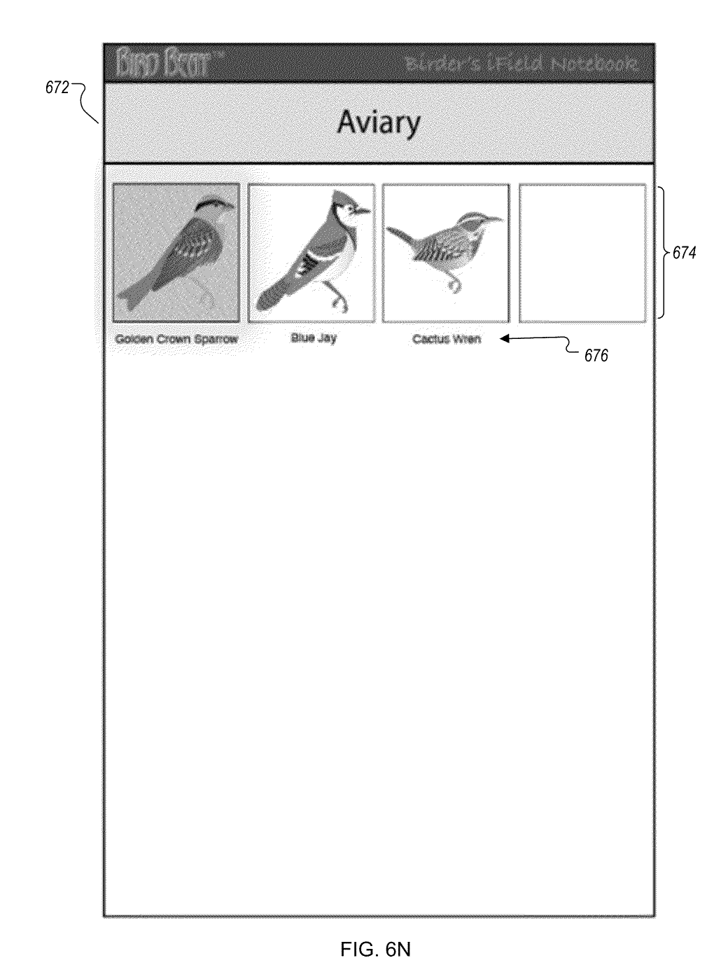

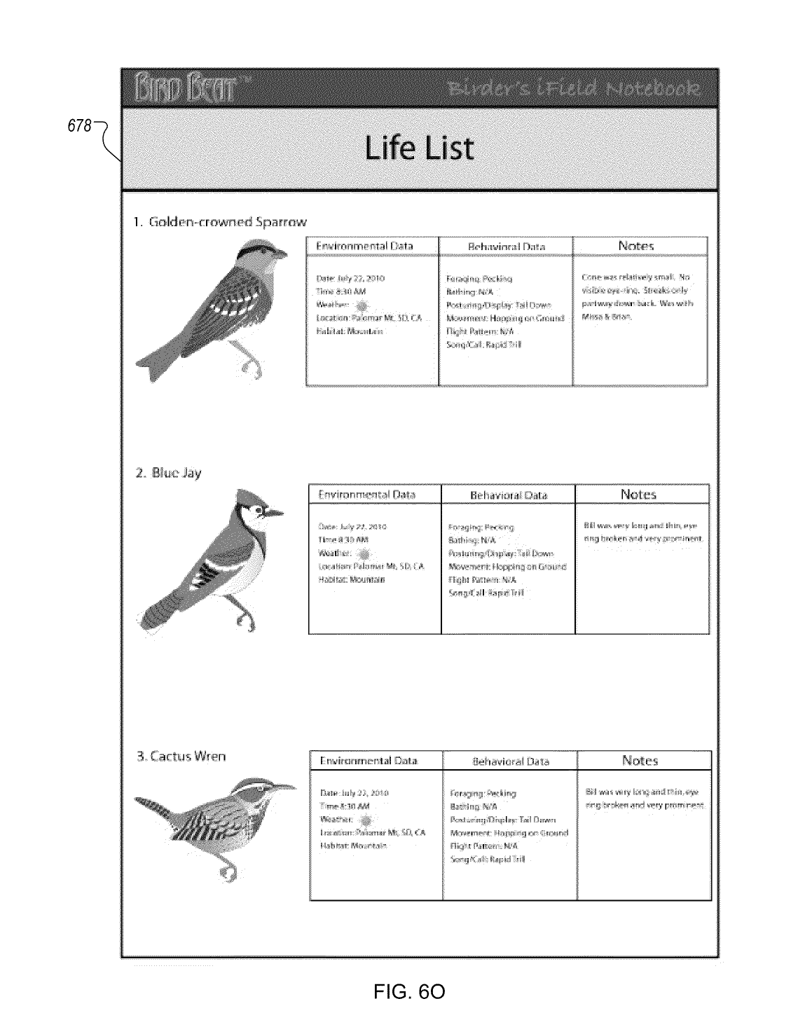

FIGS. 5A-5H show an example sequence of screens that can be used to implement the application 102 on a mobile smartphone. FIG. 5A provides an example of the first three application screens that can appear in some implementations. As a first step (step 1), a splash screen 502 can appear for a few seconds, for example, when touch device is turned on and the application is opened, before directing to a home page 504 in step 2. From the home page 504, the user can select from various options 506, including Start New Bird, Open Existing Bird, or select other interface options. In some implementations, in step 3, a user can select one of multiple bird species categories from a species screen 508. For example, in this example, the user has selected Songbirds 510, which is highlighted. Example species that are available from the screen 508 are detailed and described below with reference to FIG. 6D.

As shown in FIG. 5B, in step 4a, after selecting the Songbird category, the user is navigated to a “Select Songbird Shape” screen 512. From head options 514 (e.g., All Purpose Round, All Purpose Crested and Triangular), the user can select, for example, an All Purpose Round Head 514a. In some implementations, once the user selects a bird shape (e.g., a songbird shape), controls and functions of the application 102 can provide the user with the option to save his incomplete sketches and retrieve, edit or add to them at another time. In some implementations, a landing page to which the user is directed during a save operation can be a field sketch and data screen that is described with reference to FIG. 6L.

In some implementations, if the user has purchased a version of the application 102 that includes, for example, just the “Songbird Version of the Birder's iField Notebook,” the “Select Songbird Shape” screen 512 can open directly from the home page 504 when the “Start New Bird” options 506 is selected.

In step 4b, after selecting the Songbird Shape, the user is navigated to a Select Bill and Tail screen 516 where the user can select, for example, from available tail and bill options that correspond to the user's selected All Purpose Round shape option 514a. In this example, there are six options 518 that include multiple bill options and multiple tail options. The user can select an All Purpose Round Head Cone Bill Notch Tail option 518b, for example.

In step 4c, as shown in a template screen 520, the user now has a custom template 522a that is ready for user to utilize a variety of tools 524 to add color, pattern and texture to the template. The specific names and uses of these tools 524 are explained below with reference to FIG. 6F.

Screens 526a-526c show another example sequence of screens, indicated by steps 5a through 5c, that correspond to the user selection of an All Purpose Crested option 514b from head options 514. Among options 518 in this example, the user can select (as indicated by highlighting) an All Purpose Crest Thin Bill option 518, resulting in displaying the screen 526c that includes a custom template 522b that corresponds to crested thin-billed birds. In this example, bills are selected, but not tails, because within this category of birds, tails are typically similar.

In the example steps 6a through 6b, the user selects a Triangular option 514c from head options 514 in screen 528a. In this case, because of the similarity of bills and tails for songbirds in this category of head types (e.g., Triangular), the user is not presented with screens for selecting bills and/or tails (e.g., screen 516 and 526a). Instead, the user is presented with a screen 528b which presents a custom template 522c that corresponds to triangular-headed songbirds.

As shown in FIG. 5C, the template screen 520 shows the All Purpose Round Head Cone Bill as a completed color field drawing that includes user-specified colors, patterns and texture in step 4d. The user can save the drawing and/or navigate to the next screen.

In step 5d, an example updated version of screen 526c shows a completed template 522b for the All Purpose Round Crested Head option 518 selected in step 5b. Similarly, in step 6c, an example updated version of screen 528b shows a completed template 522c for the Triangular option 514c selected in step 6a.

In step 7, a field data screen 530 is displayed, e.g., after a user completes a template for a specific bird category (e.g., any of the templates 522a-522c that are completed in steps 4d, 5d, or 6c). In this example, the field data screen 530 includes three data options 532 (e.g., Environmental Data, Behavioral Data, and a Notepad). The field data screen 530 also displays the completed template 522a that, in this example, includes colorings selected by the user for the All Purpose Round Head songbird.

As shown in FIG. 5D, in step 8, on an example “Field Data—Environmental” screen 534′, the user has selected an Environmental Data option 536 to enter specific data regarding the sighting of the bird with the completed bird field sketch (e.g., the completed template 522a). A date entry 538a can be entered by the user or auto-entered from the device's on-board calendar. A time entry 538b can be entered by the user or auto-entered from the device's on-board clock. The user can enter a weather conditions entry 538c by selecting from available weather icons in a drop-down menu of weather icons 540. A location 538d for the bird sighting can be obtained from the device's on-board GPS or via user text entry. A habitat entry 538e can be selected from a drop-down menu 542 of habitat icons. These categories are further described below with reference to FIG. 6I

As shown in FIG. 5E, in step 9, on an example “Field Data—Behavioral” screen 544, the user has selected a Behavioral Data option 546 to enter data on key songbird behaviors 548 using drop-down menus 550. The example behavior categories 548 shown include Foraging, Bathing, Posturing/Display, Movement, Flight Pattern, and Song/Call. These categories are further described below with reference to FIG. 6J.

As shown in FIG. 5F, in step 10, on an example “Field Data—Notepad” screen 552 the user can enter any other data or notes (e.g., in a notes popup 554) that the user wants to add to further detail the specific songbird sighting and field sketch. In some implementations, the notes popup 554 can appear when the user selects a notepad option 556.

As shown in FIG. 5G, once the user has entered and saved bird and field data, the user is navigated to a Field Sketch & Data screen 558. From this screen, for example, the user can post his sketch (or his Bird Beat™ “Topo”, shorthand for Topography, the ornithological term used to refer to bird pattern marking) to a social network 560a, email it 560b, Twitter it 560c and/or post to the Bird Beat™ website 560d. In addition, each user has his own unique on-board saved Topo gallery, or “aviary.” The user can select a save to aviary option 560e to add the Topo to his aviary. The user can also add his finished Topo to his own unique on-board life list 560f each time a new bird sighting sketch is completed.

Step 12 shows an example updated version of the screen 558 after the user has selected the life list 560f option, that results in the display of a save-to control 562 (e.g., “Save To Life List”). In the text box for the save-to control 562, the user can enter the bird species name (e.g., Golden-crowned Sparrow”) or any other file name that the user chooses to enter. In some implementations, the file (and its finished Topo) can be accessed from other controls (not shown) within the application 102.

As shown in FIG. 5H, in step 13, on an aviary screen 564 (e.g., resulting from selecting the save to aviary option 560e), the user can enter the bird species name or any other file name the user chooses to enter. In this case the Topo finished sketch is added to the user's aviary.

In step 14, on an example life list screen 566 that represents the user's cumulative life list, the user can choose to save both his finished Topo and the data filed with it.

The sequences of steps 1-14 described above are example sequences of steps. Other sequence orders of the steps can be performed. Some implementations include additional steps. Some implementations omit or skip some of the steps, which can depend on the category of bird that the user is documenting.

FIGS. 6A-6O show example screens that can be used to implement the bird identification application 102 on a mobile smartphone. FIG. 6A shows an example splash screen 602 that can appear on a mobile device for which the Birder's iField Notebook is designed. The application 102 is designed to allow any user to quickly capture identifying bird markings in the field for all North American Bird Species. When the user turns on the device and selects the Bird Beat™ Birder's iField Notebook application, for example, the application 102 opens to what is referred to as the “Splash” screen, which stays active for a few seconds before going to the home page. In some implementations, the splash screen 602 can depict a live or actual bird, or the splash screen 602 can depict a finished Bird Beat™ Birder's iField Notebook field sketch, or some combination thereof (e.g., a sketch closely resembling an actual bird).

FIG. 6B shows an example home page 604 of the application 102. For example, after the splash screen 602 appears briefly and then closes, the application 102 can automatically open to the home page 604. The user can select from available options 606, such as a Start New Bird option 606a, an Open Existing Bird option 606b, or an Options option 606c. By selecting the Options option 606c, for example, the user can enter other portals on the application, such as an Aviary (e.g., a user's unique on-board library/gallery of completed field sketches) or the Life List (e.g., a user's unique on-board cumulative listing of all bird species sighted, including his completed field topos and recorded field data)

FIG. 6C shows an example select bird type screen 608. For example, as a result of selecting the “Start New Bird” option 606a from the home page 604 (e.g., as an initial step in creating a new iField sketch/topo), the user is navigated to select bird type screen 608. Various implementations of the application 102 can exist, each providing a different version of the Birder's iField Notebook. For example, customers may be able to purchase an iField Notebook application, or components (or sub-applications) thereof, for each of the individual bird species independently, or for different geographic regions. In Some implementations, a premium version can include all versions in one application, plus the ability to search a database to isolate bird identification possibilities using the completed colored and patterned iField Topo from the 900+ North American bird species.

The select bird type screen 608 includes options 610, each corresponding to a different category of birds. In some implementations, categories of birds can overlap. For example some birds (e.g., the Northern Cardinal) can be in a songbirds group 610a as well as a backyard birds group 610b. Perching birds and tree-clinging birds are other examples of birds that can be included in different bird types.

FIG. 6D shows an example select songbird shape screen 612. For example, the screen 612 can appear if the user selects the songbirds group 610a from the select bird type screen 608. The songbirds group, which can represent the largest category of all bird species in some geographic areas, is used to demonstrate the unique utilitarian properties of the system 100 and the application 102. When the user selects “Songbirds” (e.g., as represented by the glow around the selection in the previous and all subsequent screens), the user is navigated to the select songbird shape screen 612. More than 500 species of songbirds have been abstracted into three basic body shape illustrated templates from which it is possible to color, add patterns and textures to, and result in a fairly accurate visual bird marking graphic (topo) that can be used to narrow down those 500+ bird species possibilities to just a few.

The select songbird shape screen 612 includes head shape options 614 that are pertinent to the selected type of birds, Songbirds. An “All Purpose Round Head” option 614a is currently selected, as shown by highlighting or glowing.

FIG. 6E shows an example select bill and tail screen 616, the contents of which are based on the user's selection on the songbird shape screen 612 (e.g., the “All Purpose Round Head” option 614a). The select bill and tail screen 616 includes six bill and tail options 618, including combinations of straight or notched tails, and thin, thick, curved or cone bills. In this example, the user has selected an “All Purpose Round Head Cone Bill Notch Tail” option 618a. Depending on the selection made on the select bill and tail screen 616, each body shape has its own unique set of template building options.

FIG. 6F shows an example template screen 620 that has a title 622 of “All Purpose Round Head Cone Bill—Notched Tail Template.” The template screen 620 includes a custom songbird template 624 which is based on user selections from previous screens for bird type, head shape, tail type, and beak type. With these selections, the user has built a custom songbird template which is now ready for coloring, texturing and patterning using a variety of tools 626. Using the touch-screen technology, the user can touch any color on a color bar 628 (shown as various shades of gray) and drag it to any outlined (geometric) shape or area 630 on the template 624. For example, each area 630 can represent a shape that corresponds to a different anatomical area of the bird. These shapes represent specific bird topographic anatomy features, such as primary wing, secondary wing, supercilium, auricular and so forth, that are common to all songbirds. The selected color can snap to the outlined area 630. The user can vary color opacity with an opacity bar 632, apply a gradient to a color with a gradient tool 634, and erase specific areas of the sketch with an eraser tool 636 (e.g., a tool that is not constrained by the template outlines that surround a particular area 630). Patterns and textures can be added with the spot, streak and line tools 638. For close detail work, the user can pinch and zoom, a feature of most touch-screen devices.

In some implementations, when the template screen 620 (or any other screen) is displayed after the user has selected templates and/or entered information for the observed bird, the application 102 can provide messages related to the information provided up to that point. For example, based on the user's selection of a bird type, head shape, tail type, and beak type, the application 102 can a display a message such as, “You're probably seeing an osprey or a hawk, but add colors and we'll see.” In some implementations, this type of message can be generated from information stored in the computer readable medium 116, which the processor 112 can use to provide some level of bird identification independent of accessing the bird species database system 120 for identification of the observed bird.

FIG. 6G is another screen shot of the example template screen 620 with colors added to areas 630 of the template 624, representing, for example, a completed template. In this case, the user has filled in the colors and markings for the bird that user has sighted that corresponds to the “All Purpose Round Head Cone Bill Notched Tail” bird type that the user selected. As a result, the completed template 624 represents a completed “Field Marking Sketch.” In this example, while this sketch is complete, in general, the user not need to fill in this much detail in order to enter field data or save the template 624 to his Aviary or Life List. For example, the user can navigate back and forth between screens (e.g., screens 620) and provide inputs relevant to the bird sighting in any feasible order.

In some implementations, a user can create a visually accurate bird marking graphic from which to make a positive bird species identification, as well as end up with an attractive bird sketch to share electronically via email or social networks, post to the Bird Beat™ website, and add to his personal Aviary and Life List.

FIG. 6H shows an example field data screen 640 that includes a top-level menu that includes options to record ancillary data about his bird sightings (e.g., an “Environmental Data” option 642a, a “Behavioral Data” option 642b, and a “Notepad” option 642c). The “Environmental Data” and “Behavioral Data” options 642a and 642b can generate drop-down menu selections or engage existing device technology to provide speed, ease of use, convenience, consistency in terminology, organization and birding standards for the user. The “Notepad” option 642c can lead to a free-form text tool where the user may record other thoughts or observations via use of his device's keyboard.

FIG. 6I shows an example environmental data screen 644 that can appear, for example, if the user selects “Environmental Data” option 642a on the field data screen 640. In some implementations, some information that is definable upon accessing the environmental data screen 644 can be obtained from the user's phone technology, such as to automatically record a date 646a and time 646b. The user's location 646d can also be recorded if the user's device has an active GPS system. If GPS is not available, the user may enter the location 646d using keyboard entry or skip the location designation. Weather 646c and habitat 646e selections can be facilitated using drop-down menus items and illustrations, as shown in controls 648a and 648b, respectively.

FIG. 6J shows an example behavioral data screen 650 that can appear, for example, if the user selects “Behavioral Data” option 642b on the field data screen 640. On the behavioral data screen 650, the user can be directed through a series of a primary menu 652 and secondary drop-down menus 654 to select and record bird behavior relative to his sighting. Choices provided can be in accordance with typical birding and individual bird species standards for behavioral observation.

FIG. 6K shows an example notepad screen 656 that can appear, for example, if the user selects “Notepad” option 642c on the field data screen 640. By selecting the “Notepad” option 642c, the user has the flexibility to enter any additional commentary, data or observations he chooses to associate with topo/sketches. Using his device's keyboard, the user can type the information into a notebook 658 that is displayed on the notepad screen 656. Using tools 660, the user can further save the recorded notes (and completed topos), email the information to himself or others, or share the information by posting the information to the Bird Beat™ website or to his social networks.

FIG. 6L shows an example field sketch and data screen 662. In some implementations, the field sketch and data screen 662 can serve as the landing page from other screens (e.g., screens 620, 644, 650 and 656 described above). Moreover, the field sketch and data screen 662 can summarize the information for the bird sighting, including the completed template 624, environmental data 664a, behavioral data 664b, and notes 664c, entered on screens 620, 644, 650 and 656, respectively).

In some implementations, whenever the user has entered bird and field data and saves, the user can be directed to the field sketch and data screen 662, which can serve as the “Save” landing screen. From this screen, the user can use options 666 to choose to exit or re-enter the application 102 at a different spot. For example, the options 666 can include options to save his topo/sketch and related data to his Aviary (e.g., using option 666a) or Life List (e.g., using option 6660, post his topo/sketch to a social network (e.g., using option 666b), email it (e.g., using option 666d), Twit it (e.g., using option 666e), and/or post to the Bird Beat™ website (e.g., using option 666c). The field sketch and data screen 662 can essentially serve as a control portal for the user to decide what to do with his topos/sketches and other information entered for the bird sighting.

In some implementations, the field sketch and data screen 662 can include other options 666, such as an option that the user can use to identify the species of his observed bird. For example, referring to FIG. 1, the user can send his topo/sketch (e.g., using the observed bird file 118) to a comprehensive electronic field guide database or bird species database system 120 for identification of the observed bird. Upon receipt of the observed bird file 118, a search can be performed to considerably narrow the field of possible matches. In some implementations, the use can review the list of possible species matches and select one or more species names to include as information to save with his topo/sketch and other information. In some implementations, the observed bird file 118 can include information relative to the size of the bird. For example, if the user sees the bird relatively close-up (e.g., at a bird-feeder), the user can input the bird's size.

FIG. 6M shows an example save to life list screen 668 that can appear, for example, if the user selects the option 666f on the field sketch and data screen 662. When saving the information to the life list, the user can use a control 670 to personalize his topo/sketch by entering the bird species name or any other file name. The name entered in the control 670 can help the user to remember or identify his sighting. In some implementations, other controls (e.g., rename options) can allow the user to change the name that has been previously assigned to any topo/sketch and re-save under the new name.

FIG. 6N shows an example aviary top-level screen 672 that can display the user's saved topos/sketches 674 and filenames 676. When the user opts to save to his aviary (e.g., using option 666a), the user can enter the bird species name or any other file name the user chooses to help him remember or identify his sighting, just as with saving to his Life List. The user also has the option to change the name that has been previously assigned to any topo/sketch and re-save. In some implementations, should that same topo also exist in his Life List, the altered information can reflect the changes made to the corresponding Aviary topo/sketch. Upon choosing to go directly to his Aviary from the home page 604 (described with reference to FIG. 6B), the user can see each of his saved topos/sketches by image and name. In some implementations, the aviary top-level screen 672 can include other controls, such as sorting options (e.g., to sort by date, filename, bird type, etc.) or printing options (e.g., if the user's device is connected to a printer). These types of features can exist on other screens as well. In some implementations, in addition to using life lists, saved topos/sketches 674 and filenames 676 can be grouped using one or more day lists, trip lists, year lists, month lists, and other lists.

FIG. 6O shows an example life list top-level screen 678 that can appear, for example, if the user enters a filename in the control 670 on the save to life list screen 668. The screen 678 depicts what the user may see when opting to view his cumulative Life List. In some implementations, the screen 678 can be displayed when the user selects a control or portal within on the application 102 that navigates to the user's Life List. This is where the user can store his finished topos/sketches and all data associated with them. By tapping a topo, the user can make any edits, re-save, and share his topos/sketches as previously outlined. In some implementations, should that same topo also exist in his Aviary, the altered information that would normally appear in his Aviary can seamlessly reflect changes made to the corresponding Life List topo. In some implementations, the life list top-level screen 678 can include other controls, such as sorting options (e.g., to sort by date, filename, bird type, etc.) or other options.

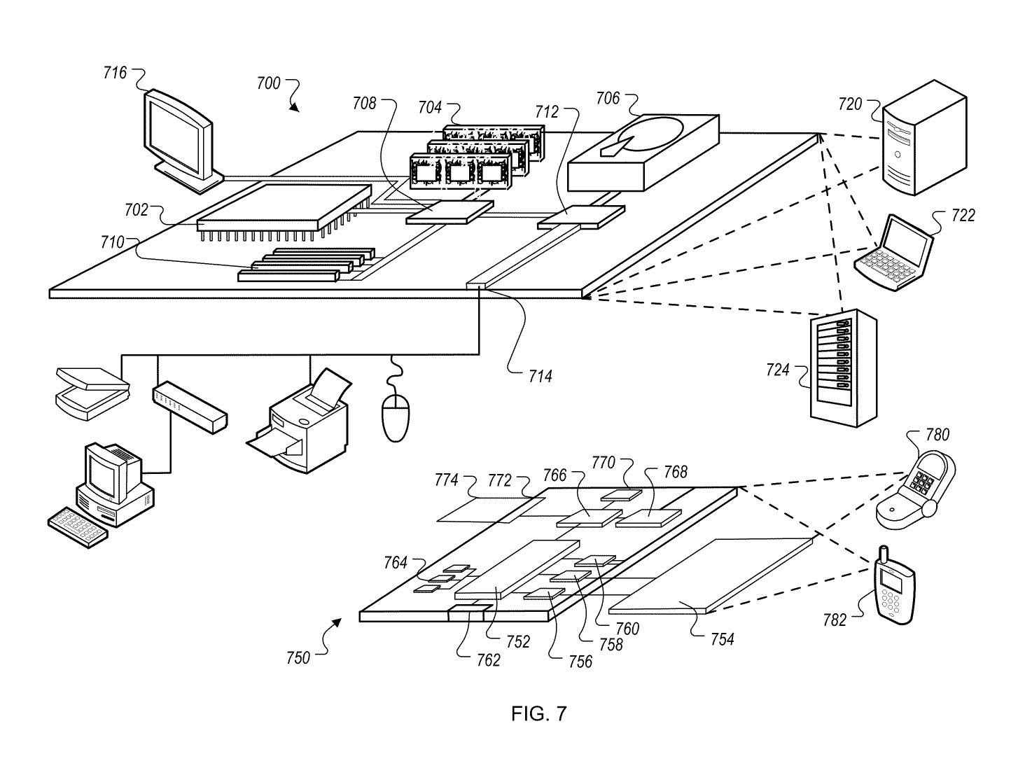

FIG. 7 shows an example of a generic computer device 700 and a generic mobile computer device 750 which may be used with the techniques described here. Computing device 700 is intended to represent various forms of digital computers, such as laptops, desktops, workstations, personal digital assistants, servers, blade servers, mainframes, and other appropriate computers. Computing device 750 is intended to represent various forms of mobile devices, such as personal digital assistants, cellular telephones, smartphones, and other similar computing devices. The components shown here, their connections and relationships, and their functions, are meant to be exemplary only, and are not meant to limit implementations of the inventions described and/or claimed in this document.

Computing device 700 includes a processor 702, memory 704, a storage device 706, a high-speed interface 708 connecting to memory 704 and high-speed expansion ports 710, and a low speed interface 712 connecting to low speed bus 714 and storage device 706. Each of the components 702, 704, 706, 708, 710, and 712, are interconnected using various busses, and may be mounted on a common motherboard or in other manners as appropriate. The processor 702 can process instructions for execution within the computing device 700, including instructions stored in the memory 704 or on the storage device 706 to display graphical information for a GUI on an external input/output device, such as display 716 coupled to high speed interface 708. In other implementations, multiple processors and/or multiple buses may be used, as appropriate, along with multiple memories and types of memory. Also, multiple computing devices 700 may be connected, with each device providing portions of the necessary operations (e.g., as a server bank, a group of blade servers, or a multi-processor system).

The memory 704 stores information within the computing device 700. In one implementation, the memory 704 is a volatile memory unit or units. In another implementation, the memory 704 is a non-volatile memory unit or units. The memory 704 may also be another form of computer-readable medium, such as a magnetic or optical disk.

The storage device 706 is capable of providing mass storage for the computing device 700. In one implementation, the storage device 706 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 704, the storage device 706, or memory on processor 702.

The high speed controller 708 manages bandwidth-intensive operations for the computing device 700, while the low speed controller 712 manages lower bandwidth-intensive operations. Such allocation of functions is exemplary only. In one implementation, the high-speed controller 708 is coupled to memory 704, display 716 (e.g., through a graphics processor or accelerator), and to high-speed expansion ports 710, which may accept various expansion cards (not shown). In the implementation, low-speed controller 712 is coupled to storage device 706 and low-speed expansion port 714. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 700 may be implemented in a number of different forms, as shown in the figure. For example, it may be implemented as a standard server 720, or multiple times in a group of such servers. It may also be implemented as part of a rack server system 724. In addition, it may be implemented in a personal computer such as a laptop computer 722. Alternatively, components from computing device 700 may be combined with other components in a mobile device (not shown), such as device 750. Each of such devices may contain one or more of computing device 700, 750, and an entire system may be made up of multiple computing devices 700, 750 communicating with each other.

Computing device 750 includes a processor 752, memory 764, an input/output device such as a display 754, a communication interface 766, and a transceiver 768, among other components. The device 750 may also be provided with a storage device, such as a microdrive or other device, to provide additional storage. Each of the components 750, 752, 764, 754, 766, and 768, are interconnected using various buses, and several of the components may be mounted on a common motherboard or in other manners as appropriate.

The processor 752 can execute instructions within the computing device 750, including instructions stored in the memory 764. The processor may be implemented as a chipset of chips that include separate and multiple analog and digital processors. The processor may provide, for example, for coordination of the other components of the device 750, such as control of user interfaces, applications run by device 750, and wireless communication by device 750.

Processor 752 may communicate with a user through control interface 758 and display interface 756 coupled to a display 754. The display 754 may be, for example, a TFT LCD (Thin-Film-Transistor Liquid Crystal Display) or an OLED (Organic Light Emitting Diode) display, or other appropriate display technology. The display interface 756 may include appropriate circuitry for driving the display 754 to present graphical and other information to a user. The control interface 758 may receive commands from a user and convert them for submission to the processor 752. In addition, an external interface 762 may be provide in communication with processor 752, so as to enable near area communication of device 750 with other devices. External interface 762 may provide, for example, for wired communication in some implementations, or for wireless communication in other implementations, and multiple interfaces may also be used.

The memory 764 stores information within the computing device 750. The memory 764 can be implemented as one or more of a computer-readable medium or media, a volatile memory unit or units, or a non-volatile memory unit or units. Expansion memory 774 may also be provided and connected to device 750 through expansion interface 772, which may include, for example, a SIMM (Single In Line Memory Module) card interface. Such expansion memory 774 may provide extra storage space for device 750, or may also store applications or other information for device 750. Specifically, expansion memory 774 may include instructions to carry out or supplement the processes described above, and may include secure information also. Thus, for example, expansion memory 774 may be provide as a security module for device 750, and may be programmed with instructions that permit secure use of device 750. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 764, expansion memory 774, or memory on processor 752 that may be received, for example, over transceiver 768 or external interface 762.

Device 750 may communicate wirelessly through communication interface 766, which may include digital signal processing circuitry where necessary. Communication interface 766 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 768. In addition, short-range communication may occur, such as using a Bluetooth, WiFi, or other such transceiver (not shown). In addition, GPS (Global Positioning System) receiver module 770 may provide additional navigation- and location-related wireless data to device 750, which may be used as appropriate by applications running on device 750.

Device 750 may also communicate audibly using audio codec 760, which may receive spoken information from a user and convert it to usable digital information. Audio codec 760 may likewise generate audible sound for a user, such as through a speaker, e.g., in a handset of device 750. Such sound may include sound from voice telephone calls, may include recorded sound (e.g., voice messages, music files, etc.) and may also include sound generated by applications operating on device 750.

The computing device 750 may be implemented in a number of different forms, as shown in the figure. For example, it may be implemented as a cellular telephone 780. It may also be implemented as part of a smartphone 782, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks; memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method comprising:
presenting, on a mobile device, selectable templates showing bird body shapes;
receiving input, on the mobile device, indicating colors for predefined regions of a bird body shown in a selected template of the multiple selectable templates, the indicated colors corresponding to an observed bird; and
storing information representing the indicated colors for the predefined regions of the bird body for later identification of the observed bird.

2. The method of claim 1, comprising:
receiving input, on the mobile device, indicating a bird type from among multiple bird types;
identifying the selectable templates for the presenting based on the input indicating the bird type;
receiving input, on the mobile device, indicating the selected template of the multiple selectable templates; and
receiving input, on the mobile device, indicating one or more sub-templates of the selected template to finalize a configuration of the selected template for use in receiving the input indicating the colors for the predefined regions.

3. The method of claim 2, wherein receiving the input indicating the bird type comprises receiving the input indicating the bird type from among the multiple bird types comprising (i) songbirds, (ii) backyard birds, (iii) waterfowl, (iv) birds of prey, (v) shorebirds and marsh birds, (vi) wading birds, (vii) seabirds, and (viii) game birds.

4. The method of claim 2, wherein receiving the input indicating the selected template comprises receiving input indicating a bird head shape template, and wherein receiving the input indicating the one or more sub-templates comprises receiving input indicating a bill shape sub-template and a tail shape sub-template.

5. The method of claim 1, wherein receiving the input indicating the colors for the predefined regions comprises receiving, on a touch screen of the mobile device, a drag-and-drop between a location on a color pallet and any location in a predefined region corresponding to an anatomical region of the observed bird, the method comprising:
displaying a color, corresponding to the location on the color pallet, snapping to the predefined region, corresponding to the anatomical region of the observed bird.

6. The method of claim 1, comprising:
receiving input indicating a gradient for a previously applied color in a first predefined region of the selected template; and
receiving input indicating an opacity for a previously applied color in a second predefined region of the selected template.

7. The method of claim 6, comprising:
receiving input indicating an erasure of previously applied colors, where the erasure crosses a boundary between two predefined regions of the selected template; and
receiving input to apply one or more patterns to the selected template, where the one or more patterns cross the boundary between the two predefined regions of the selected template.

8. The method of claim 1, wherein the storing comprises storing date, time and location on Earth data obtained from the mobile device in a file along with the information representing the indicated colors, the method comprising:
sending the file to a bird species database system for identification of the observed bird.

9. A computer-readable medium encoded with a computer program comprising instructions that cause data processing apparatus to perform operations comprising:
presenting, on a mobile device, selectable templates showing bird body shapes;
receiving input, on the mobile device, indicating colors for predefined regions of a bird body shown in a selected template of the multiple selectable templates, the indicated colors corresponding to an observed bird; and
storing information representing the indicated colors for the predefined regions of the bird body for later identification of the observed bird.

10. The computer-readable medium of claim 9, the operations comprising:
receiving input, on the mobile device, indicating a bird type from among multiple bird types;
identifying the selectable templates for the presenting based on the input indicating the bird type;
receiving input, on the mobile device, indicating the selected template of the multiple selectable templates; and
receiving input, on the mobile device, indicating one or more sub-templates of the selected template to finalize a configuration of the selected template for use in receiving the input indicating the colors for the predefined regions.

11. The computer-readable medium of claim 10, wherein receiving the input indicating the bird type comprises receiving the input indication the bird type from among the multiple bird types comprising (i) songbirds, (ii) backyard birds, (iii) waterfowl, (iv) birds of prey, (v) shorebirds and marsh birds, (vi) wading birds, (vii) seabirds, and (viii) game birds.

12. The computer-readable medium of claim 10, wherein receiving the input indicating the selected template comprises receiving input indicating a bird head shape template, and wherein receiving the input indicating the one or more sub-templates comprises receiving input indicating a bill shape sub-template and a tail shape sub-template.

13. The computer-readable medium of claim 9, wherein receiving the input indicating the colors for the predefined regions comprises receiving, on a touch screen of the mobile device, a drag-and-drop between a location on a color pallet and any location in a predefined region corresponding to an anatomical region of the observed bird, the operations comprising:
displaying a color, corresponding to the location on the color pallet, snapping to the predefined region, corresponding to the anatomical region of the observed bird.

14. The computer-readable medium of claim 9, the operations comprising:
receiving input indicating a gradient for a previously applied color in a first predefined region of the selected template; and
receiving input indicating an opacity for a previously applied color in a second predefined region of the selected template.

15. The computer-readable medium of claim 14, the operations comprising:
receiving input indicating an erasure of previously applied colors, where the erasure crosses a boundary between two predefined regions of the selected template; and
receiving input to apply one or more patterns to the selected template, where the one or more patterns cross the boundary between the two predefined regions of the selected template.

16. The computer-readable medium of claim 9, wherein the storing comprises storing date, time and location on Earth data obtained from the mobile device in a file along with the information representing the indicated colors, the operations comprising:
sending the file to a bird species database system for identification of the observed bird.

17. A system comprising:
one or more computers to provide one or more services;
a network coupled with the one or more computers; and
a mobile computing device configured to connect to the network and the one or more computers by wireless communication;
where the mobile computing device is programmed to perform operations comprising
presenting, on a mobile device, selectable templates showing bird body shapes,
receiving input, on the mobile device, indicating colors for predefined regions of a bird body shown in a selected template of the multiple selectable templates, the indicated colors corresponding to an observed bird, and
storing information representing the indicated colors for the predefined regions of the bird body for later identification of the observed bird.

18. The system of claim 17, the operations comprising:
receiving input, on the mobile device, indicating a bird type from among multiple bird types;
identifying the selectable templates for the presenting based on the input indicating the bird type;
receiving input, on the mobile device, indicating the selected template of the multiple selectable templates; and
receiving input, on the mobile device, indicating one or more sub-templates of the selected template to finalize a configuration of the selected template for use in receiving the input indicating the colors for the predefined regions.

19. The system of claim 17, wherein the mobile device comprises a touch screen, receiving the input indicating the colors for the predefined regions comprises receiving on the touch screen a drag-and-drop between a location on a color pallet and any location in a predefined region corresponding to an anatomical region of the observed bird, and the operations comprise displaying a color snapping to the predefined region.

20. The system of claim 17, comprising:
a bird species database system;
wherein the storing comprises storing date, time and location on Earth data obtained from the mobile device in a file along with the information representing the indicated colors; and
the operations comprise sending the file to the bird species database system for identification of the observed bird.
